(19) United States
(12) Patent Application Publication
(10) Pub. No.: US 2025/0244358 A1
(43) Pub. Date: Jul. 31, 2025

(54) Method And Device For Localizing Charge Traps In A Crystal Lattice

(71) Applicant: Humboldt-Universitat zu Berlin, Berlin (DE)

(72) Inventors: Tim SCHRÖDER, Berlin (DE); Gregor Pieplow, Berlin (DE); Cem Güney Torun, Berlin (DE)

(73) Assignee: Humboldt-Universitat zu Berlin, Berlin (DE)

(21) Appl. No.: 19/036,421

(22) Filed: Jan. 24, 2025

(30) Foreign Application Priority Data
Jan. 25, 2024 (DE) 102024102188.8
Sep. 23, 2024 (DE) 102024003454.4

(51) Int. Cl. G01Q 30/02; G01Q 60/00

(52) U.S. Cl. CPC G01Q 30/02; G01Q 60/00

(57) ABSTRACT

A method is presented for locating charge traps in a crystal lattice. The method includes: arranging a local probe having an inversion-symmetric lattice defect, wherein energy levels of the lattice defect are non-linearly Stark-shiftable by means of charge traps in the crystal lattice; determining Stark-shifted photoluminescence emission spectra, wherein each of the photoluminescence emission spectra is determined in a respective scanning operation by means of photoluminescence excitation in the crystal lattice; determining an integrated spectrum by integrating the photoluminescence emission spectra; determining jump probabilities from consecutive ones of the photoluminescence emission spectra and determining a charge trap configuration from the jump probabilities; determining simulated spectra by means of Monte Carlo simulation based on the determined charge trap configuration and a resulting Stark shift; and determining an optimal spatial arrangement of the charge traps neighboring the local probe by comparing the integrated spectrum with the simulated spectra.

The invention relates to a method and a device for localizing charge traps in a crystal lattice.

### BACKGROUND

So far, the local detection of charges with a local probe on a nanoscopic scale was possible mainly by a measurement of the charges in a magnetic field and for charges with a spin free in their localized state. Furthermore, applications were located on the nanometer scale and could not resolve atomic scales on an Ångström scale. A known example is the nitrogen vacancy defect center in diamond (cf. U.S. Pat. No. 10,620,251 B2). By means of nitrogen vacancy centers, it was possible with known methods to localize these charges neither with Angstrom resolution nor with time resolution.

Alternatively, electric fields can also be measured spectroscopically, for example with Rydberg atoms (cf. U.S. Pat. No. 11,585,841 B1). However, such measurements are based on the linear Stark effect in order to cause a spectral shift in the atom-like system. However, this linear reaction is susceptible to saturation of the sensor and reduces its resolution and applicability.

Detection and quantification of desired and undesired charge carriers can be of great importance both on the macroscopic and on the nanoscopic scale. Electric charges can be measured with electrometers which find diverse applications in everyday life and for fundamental scientific investigations. Electrometers have so far not been able to detect individual charges with time resolution with a resolution in the sub-nanometer range.

However, precise localization and temporal analysis of charge traps or individual charges at atomic lattice levels is becoming increasingly important. With the reduction of silicon transistors to a few nanometers, these become increasingly more susceptible to unknown and uncontrollable charge-induced noise. In ion quantum computers, for example, localized electronic states are suspected of causing decoherence due to movement heating. Superconducting qubits, in turn, suffer from defect-induced charge noise, which impairs the performance of the most sophisticated quantum computers. Finally, in the case of atom-like spin qubits in wide bandgap semiconductors, the unpredictable charge noise leads to optical and spin decoherence, which considerably limits the development of quantum networks. The investigation and elimination of the underlying mechanisms of such disadvantageous processes in each of these platforms is indispensable in order to further improve the performance and the field of application of electronic and photonic devices at the nano scale.

### SUMMARY

It is an object of the invention to provide a method and a device with which charge traps in a crystal lattice can be localized with high accuracy.

The object is achieved by means of a method and a device for localizing charge traps in a crystal lattice according to the independent claims. Embodiments are the subject matter of dependent subclaims.

According to one aspect, a method for localizing charge traps in a crystal lattice comprises the following steps:
arranging, at (on) a crystal lattice, a local probe having an inversion-symmetric lattice defect, wherein energy levels of the lattice defect are non-linearly Stark-shiftable by means of charge traps in the crystal lattice;
determining, using a readout unit, Stark-shifted photoluminescence emission spectra photoluminescence emission spectra, wherein each of the photoluminescence emission spectra photoluminescence emission spectra is determined in a respective scanning operation by means of photoluminescence excitation in the crystal lattice;
determining an integrated spectrum by integrating the photoluminescence emission spectra;
determining jump probabilities from consecutive ones (succeeding each other ones) of the photoluminescence emission spectra and determining a charge trap configuration from the jump probabilities, wherein the charge trap configuration comprises a set of charge trap states of charge traps neighboring the local probe;
determining simulated spectra by means of Monte Carlo simulation based on a determined charge trap configuration and a resulting Stark shift, wherein spatial arrangements (spatial positionings, spatial configurations) of the charge traps neighboring the local probe are varied, and
determining an optimal spatial arrangement of the charge traps neighboring the local probe by comparing the integrated spectrum with the simulated spectra.

According to a further aspect, a device for locating charge traps in a crystal lattice comprises the following:
a local probe having an inversion-symmetric lattice defect, which is arranged at a crystal lattice, wherein energy levels of the lattice defect are non-linearly Stark-shiftable by means of charge traps in the crystal lattice;
a read-out unit for photoluminescence spectroscopy; and
a data processing device.

The data processing device is configured to carry out at least one of the following steps:
determining, using the readout unit, Stark-shifted photoluminescence emission spectra, wherein each of the photoluminescence emission spectra is determined in a respective scanning operation by means of photoluminescence excitation in the crystal lattice;
determining an integrated spectrum by integrating the photoluminescence emission spectra;
determining jump probabilities from consecutive ones of the photoluminescence emission spectra and determining a charge trap configuration from the jump probabilities, wherein the charge trap configuration comprises a set of charge trap states of charge traps neighboring the local probe;
determining simulated spectra by means of Monte Carlo simulation based on a determined charge trap configuration and a resulting Stark shift, wherein spatial arrangements of the charge traps neighboring the local probe are varied, and
determining an optimal spatial arrangement of the charge traps neighboring the local probe by comparing the integrated spectrum with the simulated spectra.

By means of the proposed method or the proposed device, a determination of spatial positions of individual or a plurality of elementary charges can be made possible with time resolution and with a spatial resolution of up to a few (ca. 3) Angstroms by means of Stark shifts of a local electric field. In particular, a device with a non-linear reaction can be realized.

The local probe can be an atomic solid-state defect with a typical optical energy level structure and a non-linear electric field response due to its inversion symmetry, for example in the D_{3d} point group. In contrast to non-inversion-symmetric configurations of color centers, such as a nitrogen vacancy center in diamond or a silicon vacancy center in silicon carbide, the linear polarizability of point defects with an inversion center (e.g. the D_{3d} point group) can be largely neglected and higher-order terms can lead to a strongly non-linear reaction. This property can make local probes with an inversion center particularly sensitive to closely spaced charges and insensitive to background noise of an electric field, while at the same time maintaining sufficient measurement ranges in low-noise environments. Consequently, the spectral readout can provide an exceptionally high spatial resolution, which extends up to a few Angstroms, even at charge densities of up to a few ten ppm, which are based on the spectral shift and the line width broadening of the optical transitions induced by the charges.

By using a non-linear reaction of the electric fields of the local probe for the spatial detection of the environment of charge traps with Angstrom resolution and for the temporal observation of the dynamics of individual traps with nanosecond resolution, the spatial resolution can be increased to a few Angstroms, while the sensor/device can continue to function in an environment with a relatively high electric field background and electric field background noise. In addition, the sensor can be used for determining the local charge trap density of solid-state materials and also of solid-state surfaces. In combination with an electro-optical modulator for fast spectral readout of the sensor, the sensor could resolve up to a time resolution in the nanosecond range. Detection and quantification of desired and undesired charge carriers can be of interest in particular in the case of semiconductors, quantum computers, quantum electrometers, sensors for material quality control, materials science probes, or biological sensors.

In particular by means of charge traps in the crystal lattice (lattice), which comprise charged vacancy, energy levels of the lattice defect can be non-linearly Stark-shiftable and/or non-linearly Stark-shifted. The charge trap states of the charge traps neighboring the local probe can respectively indicate charges of the charge traps neighboring the local probe or distributions of (discrete) charges of the charge traps neighboring the local probe.

The lattice defect (of the local probe) can have a D_{3d} symmetry. In other words, the local probe can have a D_{3d}-symmetric lattice defect (a lattice defect having D_{3d} point group symmetry).

The energy levels of the lattice defect can be (substantially) non-linearly DC-Stark-shifted/-shiftable. In particular, the energy levels of the lattice defect can be (substantially) quadratic (DC-)Stark-shifted/-shiftable.

The local probe can have a tin vacancy SnV (tin vacancy, tin vacancy, tin vacancy), a silicon vacancy SiV (silicon vacancy), a germanium vacancy GeV (germanium vacancy), or a group IV vacancy. The tin vacancy can occupy two lattice sites of the crystal lattice, wherein in particular a tin atom can be arranged substantially in the middle of the two lattice sites. The same can be provided for the silicon vacancy or the germanium vacancy.

The tin vacancy, silicon vacancy or germanium vacancy can be (electrically) negatively charged.

The charge traps in the crystal lattice can comprise electrically charged simple vacancies (monovacancy) and/or double vacancies (two neighboring simple vacancies—divacancy), or teaching site complexes having N vacancies.

The crystal lattice can be a diamond lattice or a silicon lattice. The crystal lattice can be part of a solid body.

Arranging the local probe at the crystal lattice can comprise implanting the local probe within the crystal lattice. The local probe can be (after the arranging) stationary in the crystal lattice (in particular of the bulk crystal).

Arranging the local probe at the crystal lattice can comprise arranging the local probe close to and/or neighboring and/or spaced apart from the crystal lattice. In particular, the local probe can be embedded in a scanning probe microscope tip (for example for position-dependent measurements in the context of magnetometry), a nanocrystal (for example for integration with other materials), or a biological sample.

A sensor capability of the local probe can be demonstrated by means of analysis of temporally varying optical transition frequencies, which can be associated with the charging of all charge traps/crystal defects in the surrounding crystal lattice under laser irradiation.

A (charge-induced) local electric field can be determined from the spectral shift. The spatial arrangement of charge traps and in particular charge trap-probe distances can be determined by means of the determined local electric field (and the polarizability).

Each of the photoluminescence emission spectra can be determined in a respective scanning operation by means of photoluminescence excitation (PLE) in the crystal lattice under irradiation of laser light (from a laser, especially a narrow-band laser), in particular continuous orange laser light. The charge traps can additionally be excited in each scanning operation by means of a blue or green laser pulse.

The orange laser light can have a wavelength of 619 nm. The blue laser pulse can have a wavelength of 445 nm or 450 nm. The green laser pulse can have a wavelength of 520 nm. Each of the photoluminescence emission spectra can be determined with a scanning operation duration (recording duration) of five seconds.

The read-out unit can comprise or be at least one of a microscope, a spectrometer and a CCD camera. The device, in particular the read-out unit, can comprise one or more lasers, in particular for irradiation of laser pulses and/or laser light, in particular green and/or blue laser pulses and/or orange laser light.

During the scanning (during the scanning operations), the frequency of the laser light (laser frequency) can be controlled by applying an external voltage signal to the laser. The laser frequency can be monitored via a pickoff path directed onto a wave meter. The photoluminescence emission spectra can be detected as voltages and fluorescence signals. The voltages can be converted into frequencies by adjusting time stamps.

Individual scans (scanning operations) can be mapped onto a frequency axis by selecting an individual line scan/scanning operation. The scanning operation spectra can be binned (divided into bins) according to frequency (frequency binning). If a plurality of data points fall into the same bin (frequency interval), the data points can be averaged. If no data points fall into a bin, the value for the bin can be determined as the average of the previous and the next bin.

The integration of the scanning operation spectra can be carried out by (bin-wise) summation of the photoluminescence emission spectra. In particular, the integrated spectrum can be determined by mutually corresponding bins (bins of the same frequency range) of the photoluminescence emission spectra being added. Subsequently, the integrated spectrum can be normalized.

The method can further comprise the following steps:
determining a plurality of peak frequencies (central frequencies) of peaks (peak values) from the integrated spectrum and frequency ranges (configuration ranges) of the integrated spectrum assigned to the peaks;
determining scanning operation peak frequencies of scanning operation peaks for each of the photoluminescence emission spectra and assigning the scanning operation peak frequencies to a respective one of the frequency ranges of the integrated spectrum assigned to the peaks (and/or to a charge trap state); and
determining the jump probabilities from respective assigned frequency ranges (for the consecutive ones of the photoluminescence emission spectra).

Boundaries of frequency ranges of the integrated spectrum assigned to the peaks, which are neighboring, can correspond to half of the spectral distance between two neighboring peaks of the integrated spectrum.

For example, a specific scanning operation peak of a specific scanning operation can be assigned to a specific frequency range if the scanning operation peak frequency of the specific scanning operation peak is in the specific frequency range.

The jump probabilities can respectively indicate a probability of the change of the charge trap state, in particular a probability p(i→j) of the change from the charge trap state i to the charge trap state j.

The jump probabilities can respectively be determined by determining how often (proportionally of all scanning operations) a jump from one charge trap state i to another charge trap state j has occurred. Whether a jump from one charge trap state i to another charge trap state j has occurred can be determined by comparing a specific scanning operation peak from a specific scanning operation to the subsequent scanning operation peak of the subsequent scanning operation. If the specific scanning operation peak does not correspond to the subsequent scanning operation peak, a jump can be determined to have occurred.

The specific jumps from one charge trap state i to another charge trap state j can respectively be normalized with respect to a total number of all jumps in order to obtain (jump) probabilities. The jump probabilities can additionally have been respectively determined by multiplication with uncertainty factors.

The method can further comprise: determining a brightness duration of a charge trap state (or a plurality of brightness durations respectively of charge trap states) from respective assigned frequency ranges of the photoluminescence emission spectra as a time span of consecutive ones of the scanning operation spectra for which a scanning operation peak is maintained (no other scanning operation peak is determined for one of the scanning operation spectra). The brightness durations can be combined into a histogram according to the respective frequency with which they were observed, preferably in order to determine averaged lifetimes and/or switching rates. A probability density can be determined from the histogram. The probability density can be fitted (adapted) with a Poisson distribution. A lifetime τ(i) for the charge trap state i and/or a conditional spectral jump rate Γ_{ct}(i→j) can be determined from an average value of the fitted Poisson distribution.

Determining the charge trap configuration can comprise at least one of the following steps:
determining a number of peaks of the integrated spectrum and a number of jump probabilities which are greater than a predetermined threshold value;
determining charge trap states of the charge trap configuration, in particular a number of (detectable) charge traps of the charge trap configuration, from the number of peaks and the number of jump probabilities.

The charge trap configuration can indicate a (charge trap) number of the neighboring charge traps. The charge trap configuration can further indicate at least one charge (within) the neighboring charge traps.

For a number M of the peaks of the integrated spectrum, a smallest possible number for the number N of detectable charge traps can be determined by M<=2⁻¹ and a largest possible number for the number N of detectable charge traps can be the number M.

The determined charge trap configuration can be a most probable charge trap configuration and/or a charge trap configuration with fewest assumptions (a set of charge trap configurations compatible with the integrated spectrum).

Determining the charge trap configuration can in particular comprise at least one of the following steps:
determining the number of peaks of the integrated spectrum as M;
determining the number of jump probabilities which are greater than the predetermined threshold value, for example greater than 3%/M;
setting the number N of detectable charge traps equal to M;
iteratively decrementing N, determining the possible charge trap states and comparing the possible charge trap states with the number of jump probabilities greater than the predetermined threshold value until they correspond.

For M peaks, a simplest charge trap configuration can comprise N=M−1 charge traps with N charge trap states. If only individual ionization events are probable, 2*(M−1) values are expected which differ from zero (are greater than the threshold value) and are all correlated with the least red-shifted peak.

For N=M−2 charge traps, M−2 peaks can result from the ionization of M−2 individual traps, wherein a peak corresponds to no ionization and a remaining peak results from a charge trap state with two ionized charge traps. The =M−2 case can be distinguished from the N=M−1 case by those (for example four) jump probabilities which are greater than zero (or greater than the threshold value) and are not correlated with the least red-shifted peak. These non-zero elements can uniquely correlate each peak with a charge trap state.

For N=M−3 charge traps, M−3 peaks can result which are correlated with the individual ionized charge trap states. A peak can correspond to a non-ionized trap state and the remaining two peaks can be assigned to two charge trap configurations which comprise either two distinguishable, simultaneously ionized charge trap states or two charge trap states with two and three simultaneously ionized charge trap states.

To further distinguish these two possible charge trap configurations, higher-order correlations can be used to determine whether or not subsequent ionization processes have occurred. In particular, a highest-order correlation can be determined.

To determine the charge trap configuration, the jump probabilities can be arranged in a correlation matrix (probability matrix). The correlation matrix can indicate probabilities for the change from one charge trap state to another. The correlation matrix can comprise M·(M−1) entries, wherein original diagonal elements (no state change) are discarded. The rows and columns of the correlation matrix can be ordered according to peaks (charge trap states) from the smallest red shift (no ionization) to the largest red shift.

The jump probabilities which are not greater than the predetermined threshold value can be set to zero in the correlation matrix.

The jump probabilities can be determined, wherein a non-ionized case (least red-shifted peak) is started and a specific peak is reached step by step: p(0→i→ . . . T−3 steps . . . →k) (higher-order correlation matrix).

The peaks of the integrated spectrum (in particular the number of peaks and/or peak frequencies) and/or scanning operation peaks (in particular a number of scanning operation peaks and/or scanning operation peak frequencies) can be determined by means of a peak finding algorithm.

A scanning operation duration can be adapted such that at most two peaks are detected between scanning operations and/or two peaks are detected per scanning operation. In this way, at most two ionization operations can have taken place at the same time during this time interval. Consequently, the complexity of detectable charge trap configurations can be reduced.

Starting from the determined charge trap configuration, the positions (the optimal spatial arrangement) of the charge traps neighboring the local probe can be determined in different ways. On the one hand, charge trap positions at random positions can be initialized with the distances corresponding to the spectral (Stark) shifts of the assigned peaks. These distances are determined by a series of (Stark shift) equations which are decisive for DC-Stark shifts. On the other hand, the remaining free parameters (relative angles and distances) can be fine-tuned by minimizing a χ² test. Based on this χ² test, the most probable charge trap configuration and the most probable charge trap positions can be determined.

When determining simulated spectra by means of Monte Carlo simulation based on a determined charge trap configuration and a resulting Stark shift, spatial arrangements of the charge traps neighboring the local probe and charges of the charge traps neighboring the local probe can be varied. When determining simulated spectra by means of Monte Carlo simulation based on a determined charge trap configuration and a resulting Stark shift, spatial arrangements of the charge traps remote from the local probe and/or charges of the charge traps remote from the local probe can also be varied.

Determining the simulated spectra can comprise at least one of the following steps:
determining approximate values for first location values of the spatial arrangements from relative Stark shifts from the integrated spectrum, and
fine tuning the first location values by means of (the) Monte Carlo simulation(s), wherein the first location values and second location values of the spatial arrangements are varied.

In particular, the optimal spatial arrangement can comprise fine-tuned first location values and optimal second location values.

Alternatively, (both first and second) location values can be determined by means of Monte Carlo simulation, wherein the (first and second) location values of the spatial arrangements are varied, so that preferably a χ² distribution from the integrated spectrum and the simulated spectra can be minimized.

Furthermore, during the fine tuning of the first location values by means of Monte Carlo simulation,
a charge trap density ρₜᵣₐₚ of the charge traps remote from the local probe can be varied. Alternatively, the charge trap density ρₜᵣₐₚ and/or a spatial distribution of charges remote from the local probe can be predefined. For example, the spatial distribution of the charges remote from the local probe can be estimated on the basis of a physical model (such as the distribution of implantation damage). Without a physical model, a predefined charge distribution (e.g. cylindrically symmetrical) can be established.

The first and/or the second location values can comprise spherical coordinates which indicate spatial arrangements of the charge traps neighboring the local probe (relative to the local probe).

The first location values can for example comprise at least one of the following variables: a first distance r₁ of a first charge trap from the local probe, a first azimuth angle or polar angle θ₁ of the first charge trap with respect to the local probe, a second distance r₂ of a second charge trap from the local probe, a second azimuth angle or polar angle θ₂ of the second charge trap with respect to the local probe, a third distance r₃ of a third charge trap from the local probe and a third azimuth angle or polar angle θ₃ of the third charge trap with respect to the local probe.

The first location values can in particular comprise at least one of the following variables: the first distance r₁ of the first charge trap from the local probe, the third distance r₃ of the third charge trap from the local probe and the third azimuth angle or polar angle θ₃ of the third charge trap with respect to the local probe.

The first location values (in particular the first distance r₁, the third distance r₃ and the third azimuth angle or polar angle θ₃) can (for example in the case of two charge traps and/or four peaks) be determined from the relative Stark shifts ΔΔ_{◯}, Δ_{◯⊙}, Δ_{⊙◯}, Δ_{⊙⊙} by means of the following (Stark shift) equations:

$${Δ}_{○○} = - \frac{Δ α}{2} {E ( - 1 , {\vec{r}}_{2} )}^{2}$$

$${Δ}_{○ ⊙} = - {\frac{Δ α}{2} [ E ( - 1 , {\vec{r}}_{2} ) + E ( - 1 , {\vec{r}}_{1} ) ]}^{2}$$

$${Δ}_{⊙ ○} = - {\frac{Δ α}{2} [ E ( - 1 , {\vec{r}}_{2} ) + E ( - 1 , {\vec{r}}_{3} ) ]}^{2}$$

$${Δ}_{⊙ ⊙} = - {\frac{Δ α}{2} [ E ( - 1 , {\vec{r}}_{2} ) + E ( - 1 , {\vec{r}}_{1} ) + E ( - 1 , {\vec{r}}_{3} ) ]}^{2}$$

Δαrepresents the second-order polarizability and E(−1,\vec{r}ᵢ)² the square of the magnitude of the electric field of the electric trap i with elementary charge−1

$$( E ( {q}_{i} , r ) = \frac{{q}_{i}}{4 {πϵ}_{0} {ϵ}_{r}} \frac{r}{{r}^{3}} , {q}_{i} ∈ e \cdot \{ - 1 , 0 , + 1 \} ,$$

elementary charge e). A neutral charge trap is designated by ◯ and a negatively charged charge trap by ⊙. Consequently, a charge trap state with, for example, neutral first charge trap and negatively charged second (or third) charge trap is designated by ◯⊙.

The relative Stark shifts Δ_{◯◯}, Δ_{◯⊙}, Δ_{⊙◯}, Δ_{⊙⊙} can be determined from the integrated spectrum, in particular from the peak frequencies of the peaks of the integrated spectrum, wherein the peaks are respectively fitted by means of Voigt profiles.

The first, second, and third charge trap can be arranged in a common plane. In particular, the first and the second charge trap can be arranged in a common plane. The azimuth angles and/or polar angles can be defined with respect to the common plane. The second charge trap can be arranged with respect to the local probe along a direction of the implantation of the local probe. The first charge trap can be arranged with respect to the local probe perpendicular to the direction of the implantation.

For example, the spatial arrangements of the first, second, and third charge trap can be parameterized as follows: \vec{r}₁=r₁[cos(θ₁),0,sin(θ₁)], \vec{r}₂=[0,0,r₂], \vec{r}₃=[cos(θ₃),0,sin(θ₃)].

When determining the simulated spectra, charges of the charge traps neighboring the local probe and charges remote from the local probe can further be varied. Charge traps remote from the local probe can for example have a distance of at least 2.5 nm (25 Å) from the local probe. In contrast, charge traps neighboring the local probe can have a distance of less than 2.5 nm (25 Å) from the local probe.

The second location values can for example comprise at least one of the following variables: the first azimuth angle or polar angle θ₁ of the first charge trap with respect to the local probe and the second distance r₂ of the second charge trap from the local probe.

Comparing the integrated spectrum with the simulated spectra can comprise minimizing a χ² distribution and/or a χ² test from the integrated spectrum and the simulated spectra.

The minimization can be carried out by means of a global optimization algorithm, in particular simplicial homology global optimization (shgo).

The χ² distribution can be represented by the following function:

$${\sum }_{i} χ ( θ , i ) = {\sum }_{n = 0 , i}^{N} \frac{{( {O}_{n} ( θ , i ) - {E}_{n , i} )}^{2}}{{E}_{n , i}}$$

with values Oₙ(θ,i) of the simulated spectra and values E_{n,i} of the integrated spectrum for bin n (in particular with Oₙ(θ,i) as the number of expected counts for peak i and bin n and the corresponding value E_{n,i} of the integrated spectrum, wherein a vector θ indicates at least one of the first location values). For example, the vector e can indicate the first and the third distance, especially θ=[a,b] with fine tuning factors a, b, wherein r₁′=ar₁ and r₃′=br₃.

In other words, comparing the integrated spectrum with the simulated spectra can comprise minimizing

$${\sum }_{i} χ ( θ , i ) = {\sum }_{n = 0 , i}^{N} \frac{{( {O}_{n} ( θ , i ) - {E}_{n , i} )}^{2}}{{E}_{n , i}}$$

with values Oₙ(θ,i) of the simulated spectra and values E_{n,i} of the integrated spectrum for bin (interval) n, peak i and vector θ of first location values. For example, 170 bins of the same width can be provided over a frequency range of 4 GHz.

The simulated spectra and/or the integrated spectrum can be divided into partial spectra (parts of the spectra). The values {Oₙ(θ,i)}ₙ or {E_{n,i}}ₙ can be understood as parts of the total simulated spectra or of the total integrated spectrum {Oₙ(θ,i)}_{n,i} or {E_{n,i}}_{n,i}. The parts of the spectra can also be partially combined. For example, the spectra can be divided according to i∈{◯◯,◯⊙,⊙◯+⊙⊙}.

The integrated spectrum (and/or its parts/partial spectra) can be adapted by (single or double) Voigt profile adaptation (Voigt profile fits) before the comparison with the simulated spectra.

The values Oₙ(θ,i) of the simulated spectra can be determined by means of the formula S(ω)=1/NΣₙL_{γ}(ω−Δ_{stark,n}) (with normalization constant N (so that max S(ω)=1), simulation step index n, Stark shift Δ_{stark,n} for simulation step n and Lorentz curve Ly with full width at half maximum γ (e.g. γ=35 MHz for local probe SnV⁻¹)). For the simulated spectra, determining the Stark shift Δ_{stark,n} can comprise linear and higher-order terms. In particular, the Stark shift Δ_{stark,n} can be determined for each simulation step n by means of the formula

$${Δ}_{stark} = - Δ μ {E}_{s} - \frac{1}{2} Δ α {E}_{s}^{2} - \frac{1}{3 !} Δ β {E}_{s}^{3} - \frac{1}{4 !} Δ γ {E}_{s}^{4}$$

(with dipole moment Δμ=6.1×10⁻⁴ Ghz/(MV/m)² and differences between higher-order polarizabilities Δα=−5.1×10⁻⁵ GHz/(MV/m)², Δβ=−5.5×10⁻⁸ GHz/(MV/m)² and Δγ=−2.2×10⁻¹⁰ GHz/(MV/m)²), wherein here Eₛ depends on the simulation step n.

The second location values (e.g. the first azimuth angle or polar angle θ₁ and the second distance r₂) and/or the charge trap density ρₜᵣₐₚ can be varied (within optimization intervals), for example ρₜᵣₐₚ∈[35, 100] ppm or θ₁∈[0; 0.6] rad. This variation can be carried out, for example, over 500 iterations.

Within each of the iterations, that is to say for fixed second location values (e.g. the first azimuth angle or polar angle θ₁ and the second distance r₂) and/or fixed charge trap density ρₜᵣₐₚ of the charge traps remote from the local probe, the charge locations remote from the local probe can in each case be spatially distributed randomly with respect to the local probe according to the charge trap density ρₜᵣₐₚ (upon implantation of the local probe within a cone volume (z>0 nm, the local probe is arranged in the coordinate origin) with aperture angle 45°, wherein for r_{q}<2.5 nm no charge locations remote from the local probe are distributed). The spatial distribution can be carried out according to a uniform distribution. Furthermore, the neighboring charge traps can be charged according to charge probabilities. In the case of two neighboring charge traps with temporally variable charge, the charge probabilities can be, for example, P_{⊙⊙}=0.041, p_{⊙◯}=0.017, p_{◯⊙}=0.63 and p_{◯◯}=0.31. The charges for the neighboring charge traps can assume values qᵢ·e with qᵢ∈{−1,0,+1} and elementary charge e, wherein charge neutrality including the negative charge of the local probe is ensured (−e+eΣᵢqᵢ=0). Accordingly, the field strength at the location of the local probe can be E=ΣᵢE(qᵢ,rᵢ).

The spatial distribution of the charge traps remote from the local probe and the charging of the neighboring charge traps can be repeated for fixed second location values and/or fixed charge trap density ρₜᵣₐₚ for example 1000 times. The charge probabilities of the neighboring traps can be determined from (possibly normalized) peak heights of the peaks of the integrated spectrum.

At least one of the neighboring charge traps (for example the second charge trap) can be determined as permanently charged. A permanently charged charge trap can lead to a peak broadening.

For fixed second location values and/or fixed charge trap density ρₜᵣₐₚ and distributed charge locations remote from the local probe and charged neighboring charge traps, (in the context of a Monte Carlo simulation) the first location values (or parts thereof, in particular r₁ and r₃) can be fine-tuned. For this purpose, respectively the χ² distribution can be minimized with

$${\sum }_{i} χ ( θ , i ) = {\sum }_{n = 0 , i}^{N} \frac{{( {O}_{n} ( θ , i ) - {E}_{n} )}^{2}}{{E}_{n}}$$

with θ=[a,b] and fine tuning factors a, b, wherein r₁′=ar₁ and r₃′=br₃. The minimization is respectively carried out by means of simplicial homology global optimization (shgo).

The fine-tuned first location values (or parts thereof, in particular r₁ and r₃ or r′ and r₃′) can be compiled (together with the corresponding χ² values) for the (varied) second location values and/or the (varied) charge trap density ρₜᵣₐₚ (in particular tabulated).

The optimal spatial arrangement of (neighboring) charge traps can comprise the fine-tuned first location values and the second location values with the smallest χ² value or alternatively from a respective weighted average of several smallest (for example the 50 smallest) χ² values. The optimal spatial arrangement can also comprise further optimized (first) location values, which were determined by means of the Stark shift equations from the remaining first or second location values. In particular, the (optimized, first) location value θ₃ can be determined by means of the Stark shift equations from the (optimized) second location value θ₁.

Confidence intervals for the (first and/or second) location values and/or further values of the optimal spatial arrangement can be determined using χ² values (for example a weighted average of the 50 smallest χ² values together with an offset value). In particular, 68% confidence intervals for ρₜᵣₐₚ and/or θ₁ can be determined by means of min{χ²}+3.5.

The data processing device can have a processor and/or a memory.

At least one, preferably each of the steps determining the plurality of Stark-shifted photoluminescence emission spectra, determining the integrated spectrum, determining the jump probabilities, determining the simulated spectra and determining the optimal spatial arrangement and intermediate steps or further steps can be carried out by means of a data processing device.

According to the disclosure, furthermore a method can be provided, preferably for locating charge traps in a crystal lattice, which comprises at least one of the following steps:
arranging, preferably at a crystal lattice, a local probe having an inversion-symmetric lattice defect, wherein further preferably by means of charge traps in the crystal lattice energy levels of the lattice defect are (substantially) non-linearly Stark-shiftable (Stark-shifted);
determining, preferably using a readout unit, Stark-shifted photoluminescence emission spectra (line scan spectra), wherein preferably each of the photoluminescence emission spectra is determined in a respective scanning operation (line scan) by means of photoluminescence excitation in the crystal lattice;
determining an integrated spectrum, preferably by integrating the photoluminescence emission spectra;
determining jump probabilities, preferably from consecutive ones of the photoluminescence emission spectra, and/or determining a charge trap configuration from the jump probabilities, wherein further preferably the charge trap configuration comprises a set of charge trap states of charge traps neighboring the local probe;
determining simulated spectra by means of Monte Carlo simulation(s) (based on the determined charge trap configuration) and a resulting Stark shift(s), wherein spatial arrangements of the charge traps neighboring the local probe are varied, and
determining an optimal spatial arrangement of the charge traps neighboring the local probe by comparing the integrated spectrum with the simulated spectra.

According to the disclosure, furthermore a device can be provided, preferably for locating charge traps in a crystal lattice, which comprises at least one of the following:
a local probe having an inversion-symmetric lattice defect, which is preferably arranged at a crystal lattice, wherein further preferably by means of charge traps in the crystal lattice energy levels of the lattice defect are non-linearly Stark-shiftable;
a read-out unit for photoluminescence spectroscopy; and
a data processing device.

The data processing device is in particular configured to carry out at least one of the following steps:
determining, preferably using the readout unit, Stark-shifted photoluminescence emission spectra, wherein further preferably each of the photoluminescence emission spectra is determined in a respective scanning operation by means of photoluminescence excitation in the crystal lattice;
determining an integrated spectrum, preferably by integrating the photoluminescence emission spectra;
determining jump probabilities, preferably from consecutive ones of the photoluminescence emission spectra, and/or determining a charge trap configuration from the jump probabilities, wherein further preferably the charge trap configuration comprises a set of charge trap states of charge traps neighboring the local probe;
determining simulated spectra by means of Monte Carlo simulation(s), preferably based on a determined charge trap configuration, and a resulting Stark shift(s), wherein in particular spatial arrangements of the neighboring charge traps are varied, and
determining an optimal spatial arrangement of the neighboring charge traps by comparing the integrated spectrum with the simulated spectra.

In connection with the device for localizing charge traps in a crystal lattice, the embodiments described above in connection with the method can be provided accordingly.

### DESCRIPTION OF EXEMPLARY EMBODIMENTS

Further exemplary embodiments are explained in more detail below with reference to figures of a drawing. In the figures:

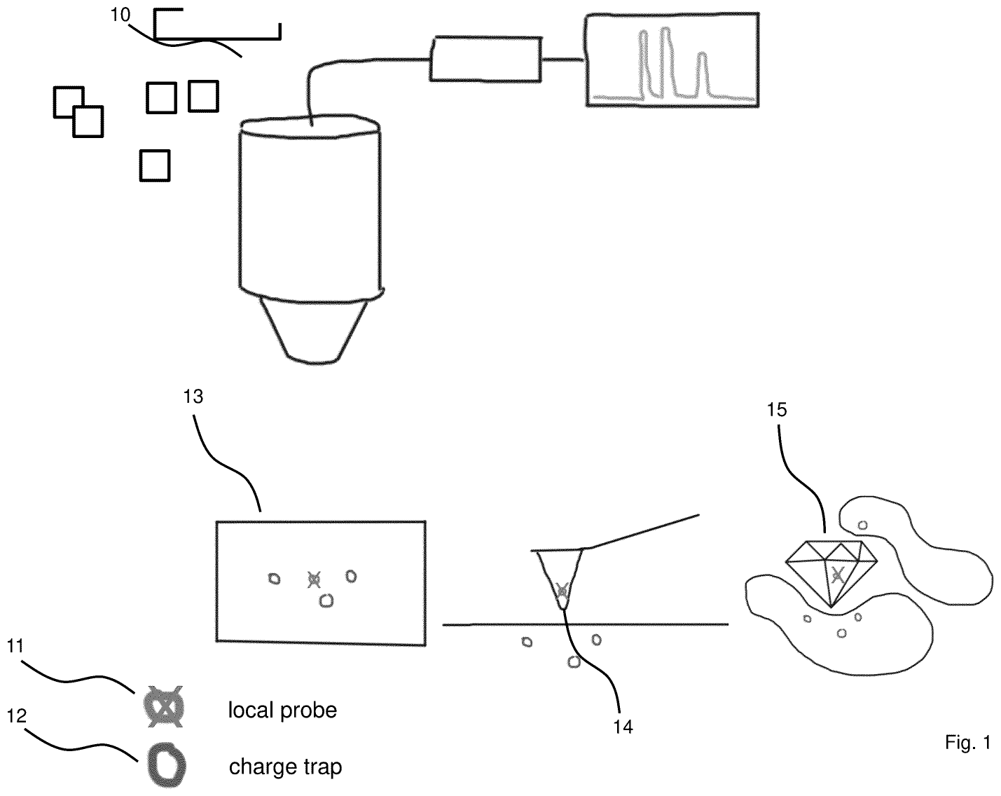

FIG. 1 shows a schematic illustration of a device for localizing charge traps,

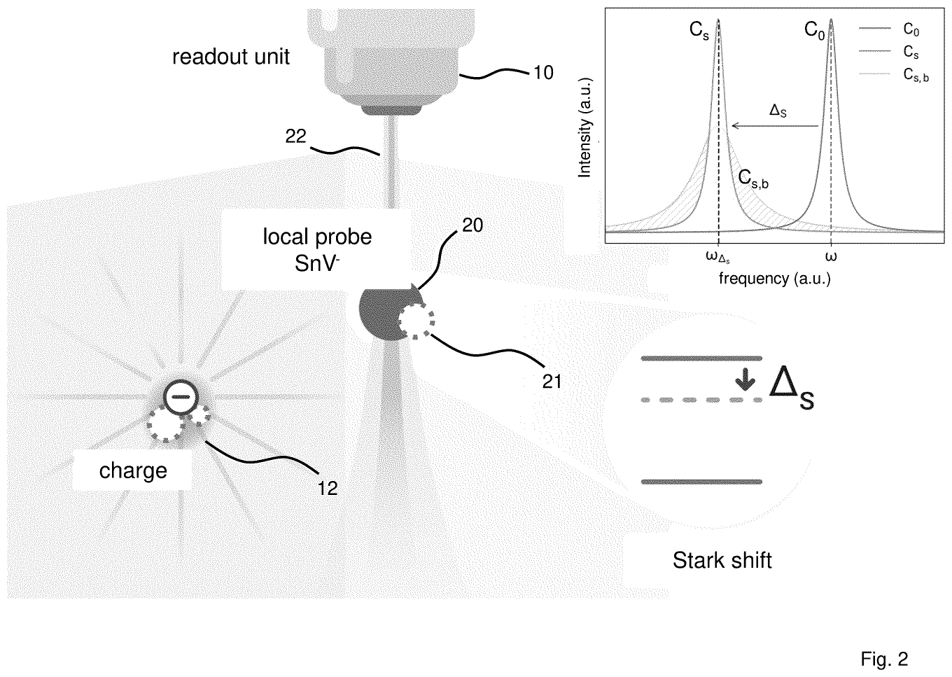

FIG. 2 shows a schematic illustration of the device for localizing charge traps in a crystal lattice by means of Stark shift,

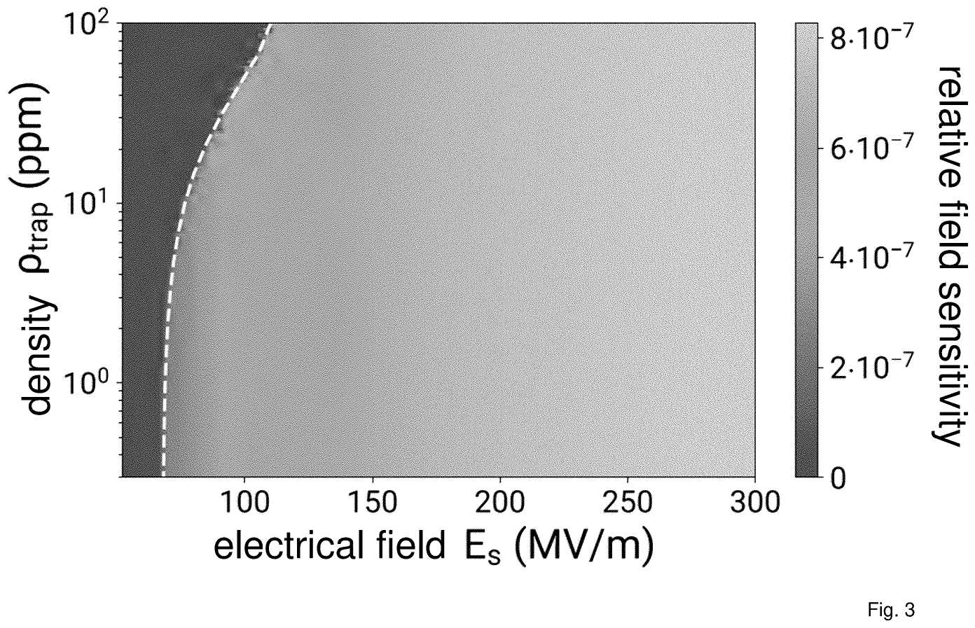

FIG. 3 shows a plot of a relative sensitivity |ΔE|/E to changes of an electric field as a function of an electric field Eₛ and a charge trap density ρₜᵣₐₚ,

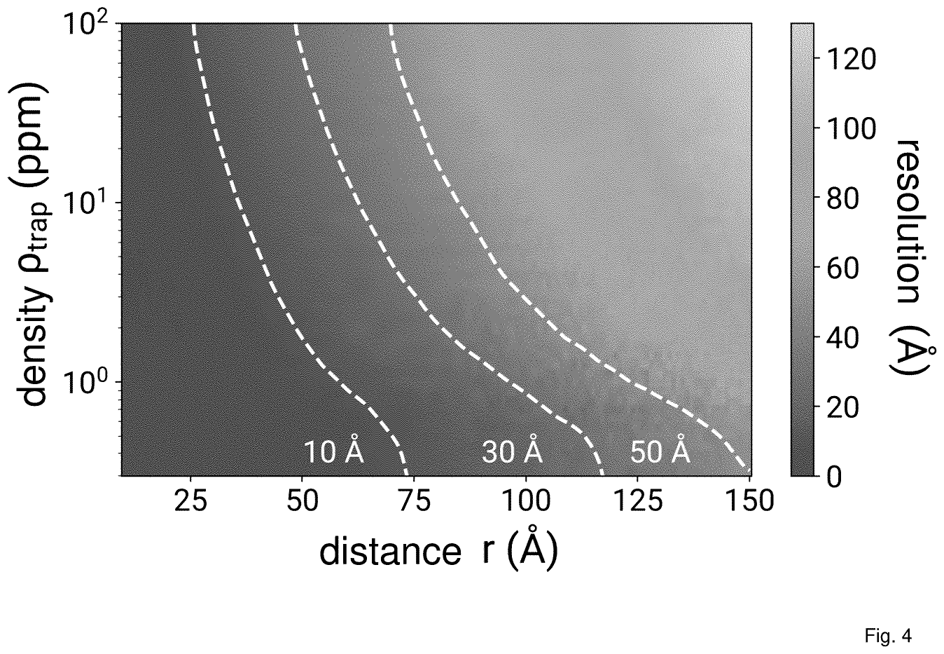

FIG. 4 shows a plot of the resolution of the sensor in the determination of the distance of an elementary charge based on the distinction of two different charge traps as a function of the charge trap density ρₜᵣₐₚ and the distances,

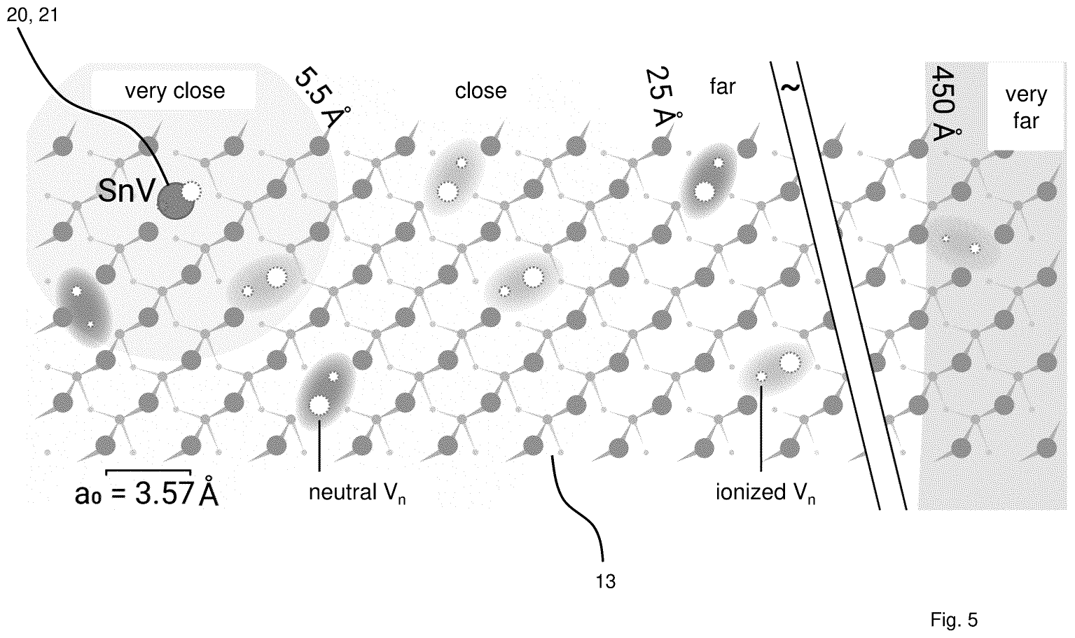

FIG. 5 shows a schematic illustration of a crystal lattice having a tin vacancy and lattice defects,

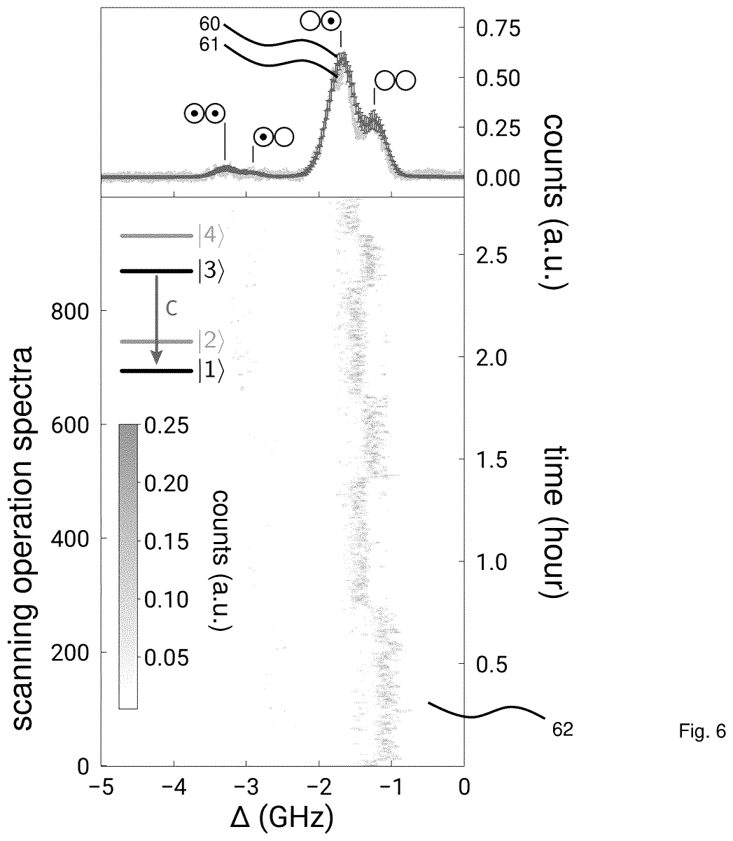

FIG. 6 shows a plot of the integrated spectrum and of the simulated spectrum with assignment of the peaks to the charge trap states and plot of the photoluminescence emission spectra as a function of the Stark shift,

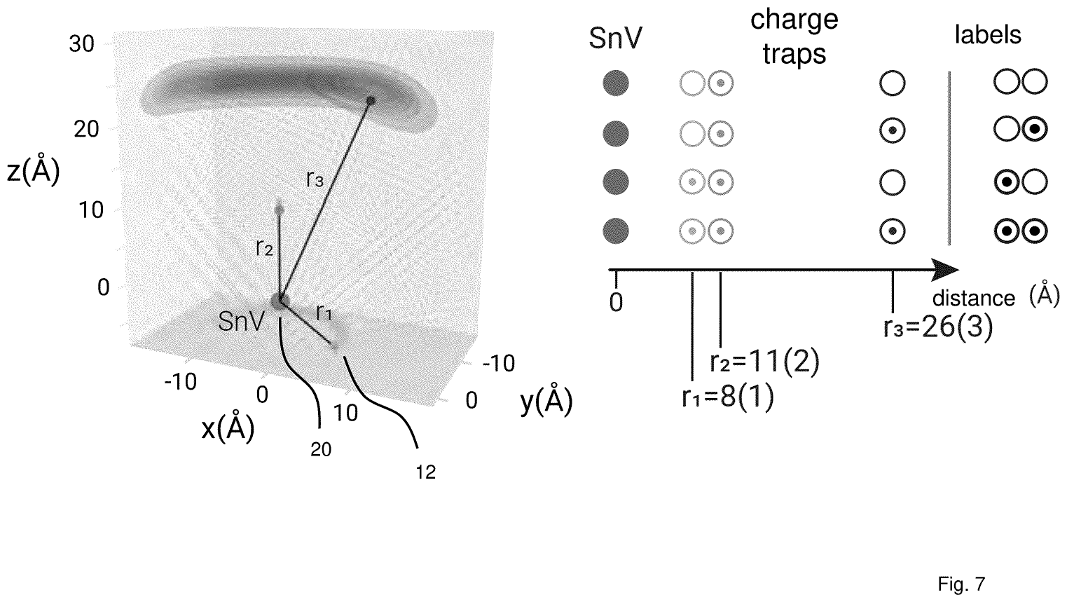

FIG. 7 shows a schematic illustration of the relative positions of the charge traps and their probability distribution with respect to an SnV probe and a table with indication of the charge trap states and the position of the identified charge traps,

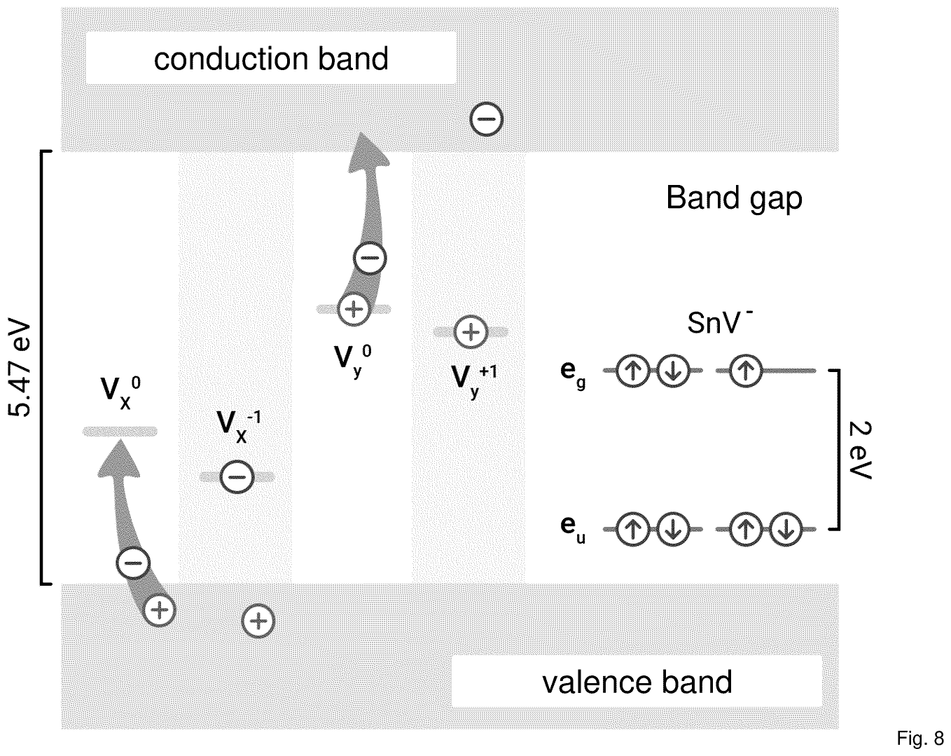

FIG. 8 shows a schematic illustration of the SnV probe, of the ionized and neutral lattice defects in the bandgap,

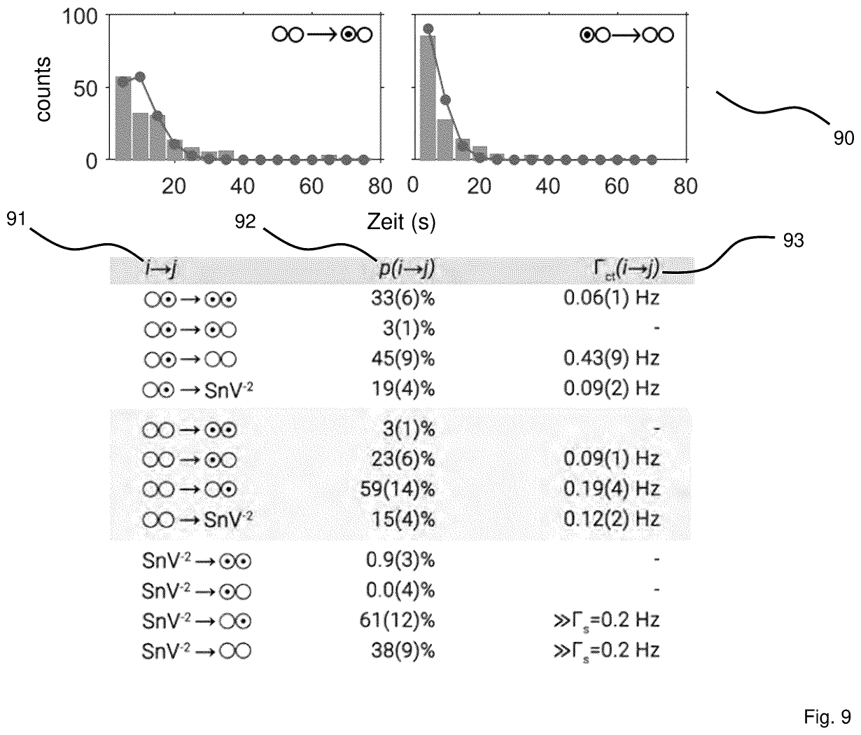

FIG. 9 shows example histograms which show how long the charge remains in one charge trap state until it changes into another and a table with jump probabilities and jump rates to the corresponding spectral jumps,

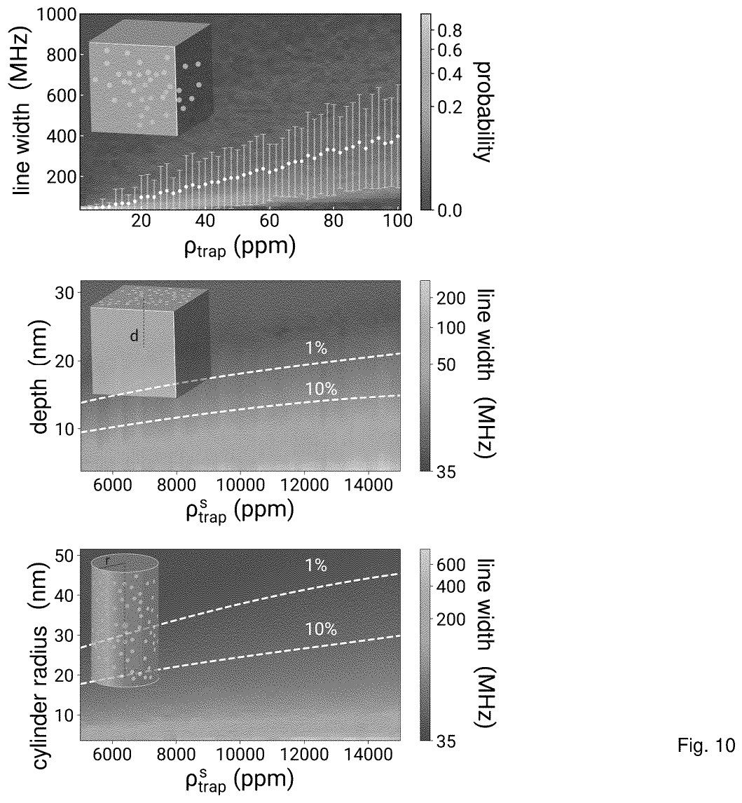

FIG. 10 shows plots of the inhomogeneous broadening of the SnV zero phonone line on account of bulk and surface charges,

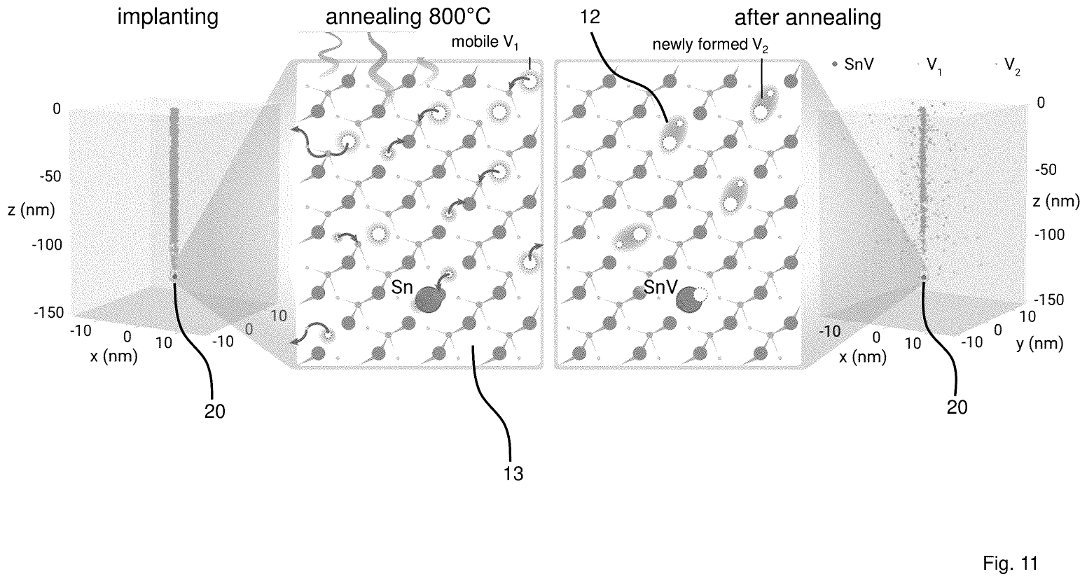

FIG. 11 shows a schematic illustration of a formation of double charge traps in the crystal lattice during an annealing process,

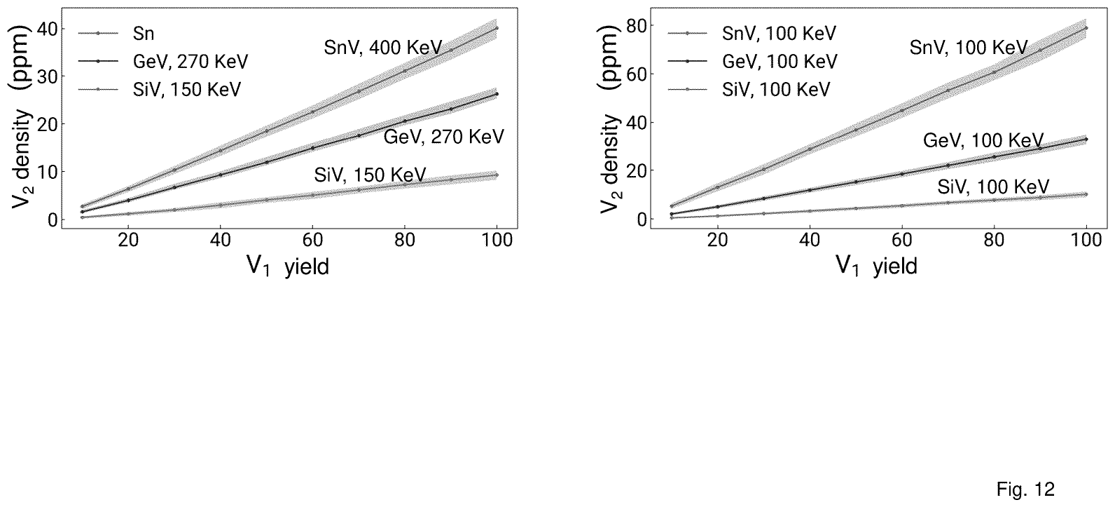

FIG. 12 shows plots of the simulated densities of the double charge traps as a function of the single charge traps for three different species of color centers,

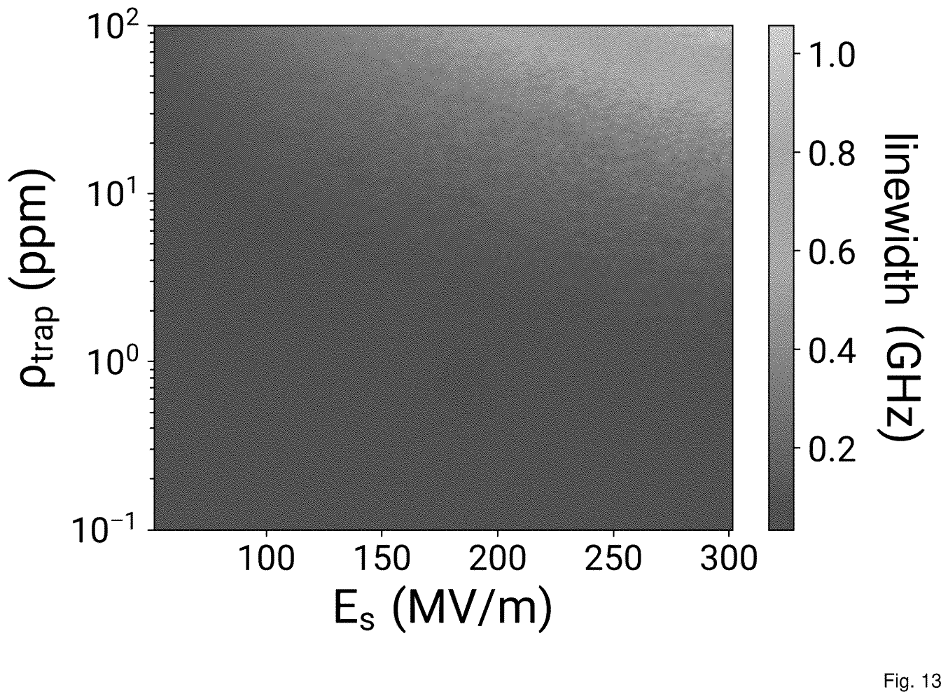

FIG. 13 shows a plot of the inhomogeneous broadening as a function of the local bias field,

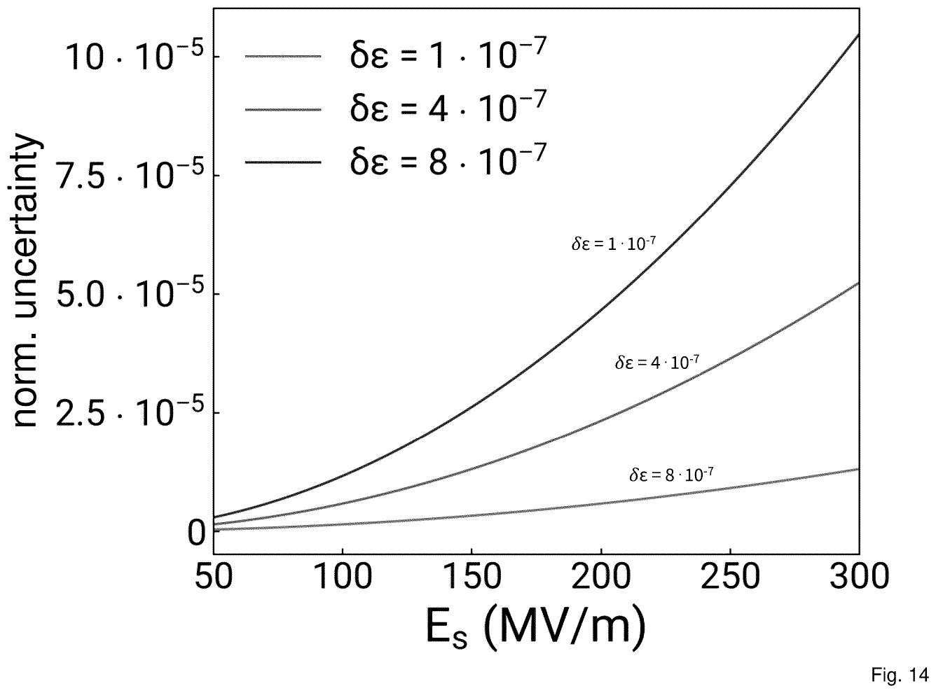

FIG. 14 shows a plot of the normalized uncertainty to the homogeneous line width for three different values of the relative sensitivity of the electric field,

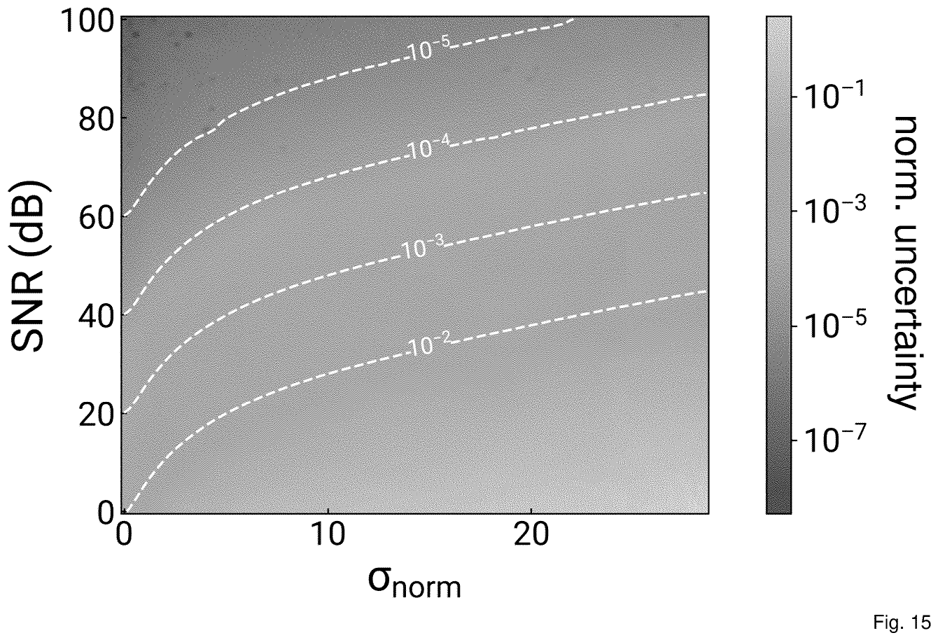

FIG. 15 shows a plot of the uncertainty extracted from a fitting as a function of the SNR and the Gaussian component of the Voigt profile, both normalized to the homogeneous line width,

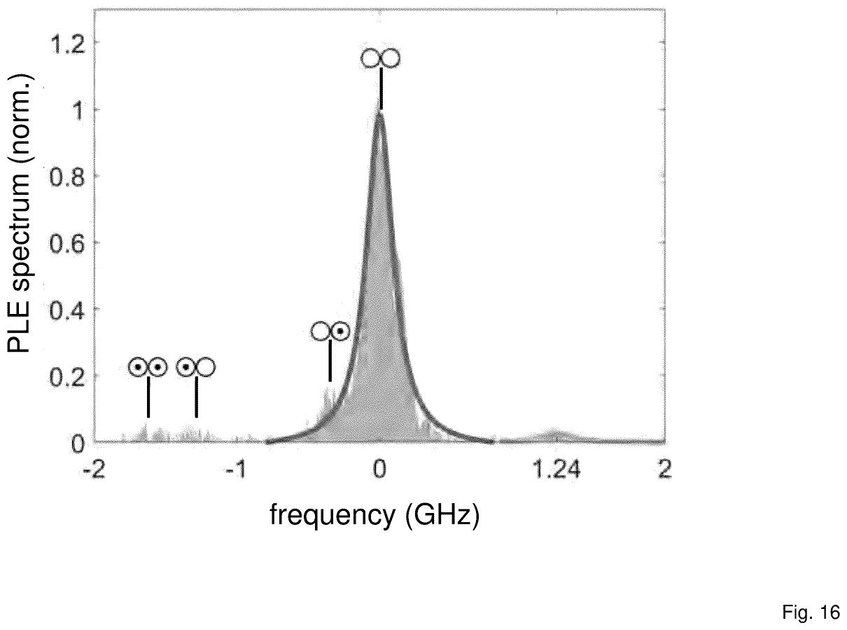

FIG. 16 shows a plot of the experimental estimation of the bias field at the sensor,

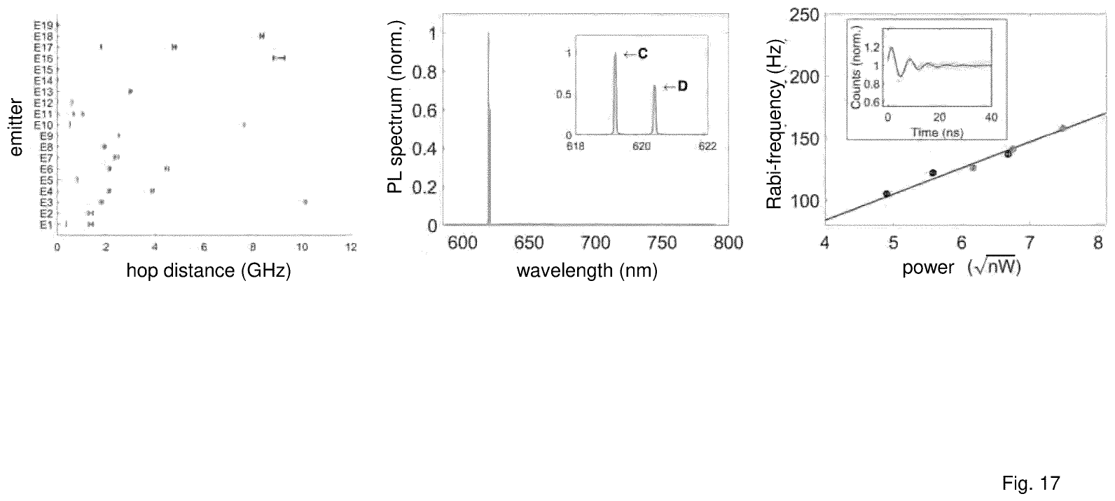

FIG. 17 shows plots of control experiments,

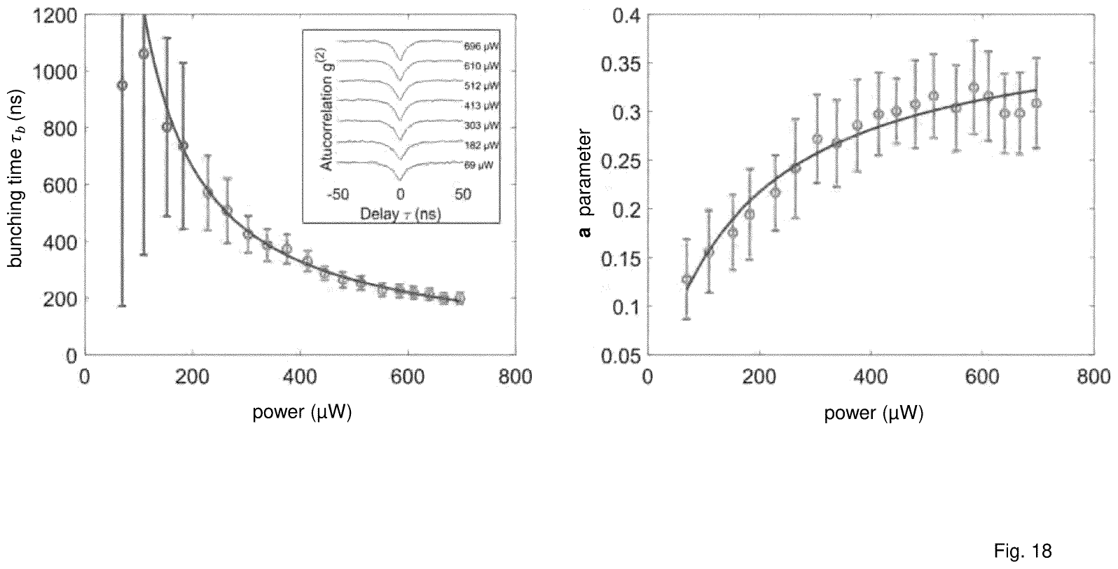

FIG. 18 shows plots of extracted parameters from autocorrelation measurements for an emitter E1,

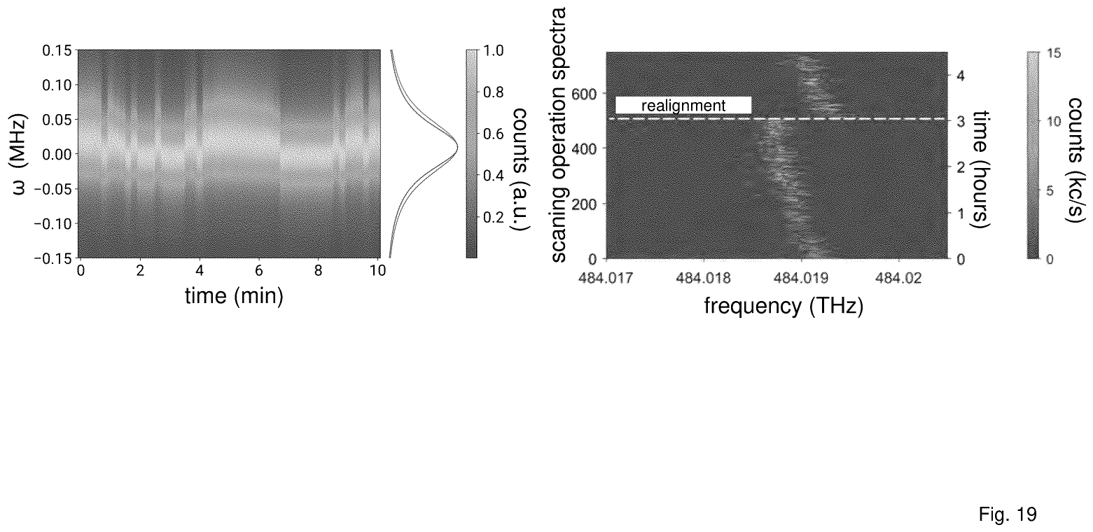

FIG. 19 shows plots of the influence of the laser misalignment on the photoluminescence emission spectra,

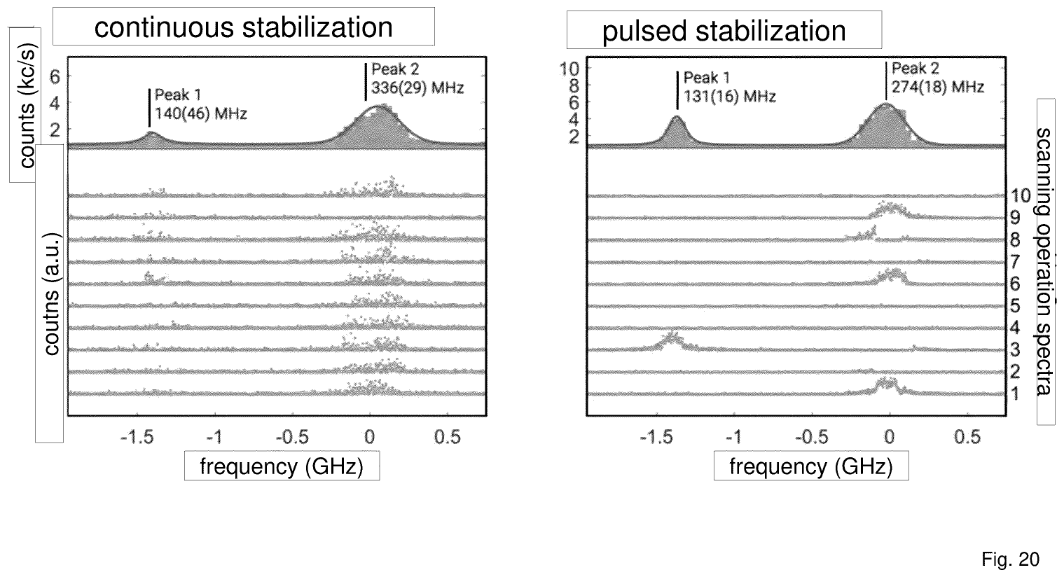

FIG. 20 shows plots of the photoluminescence excitations of the C-junction under different charge stabilization schemes at the emitter E1,

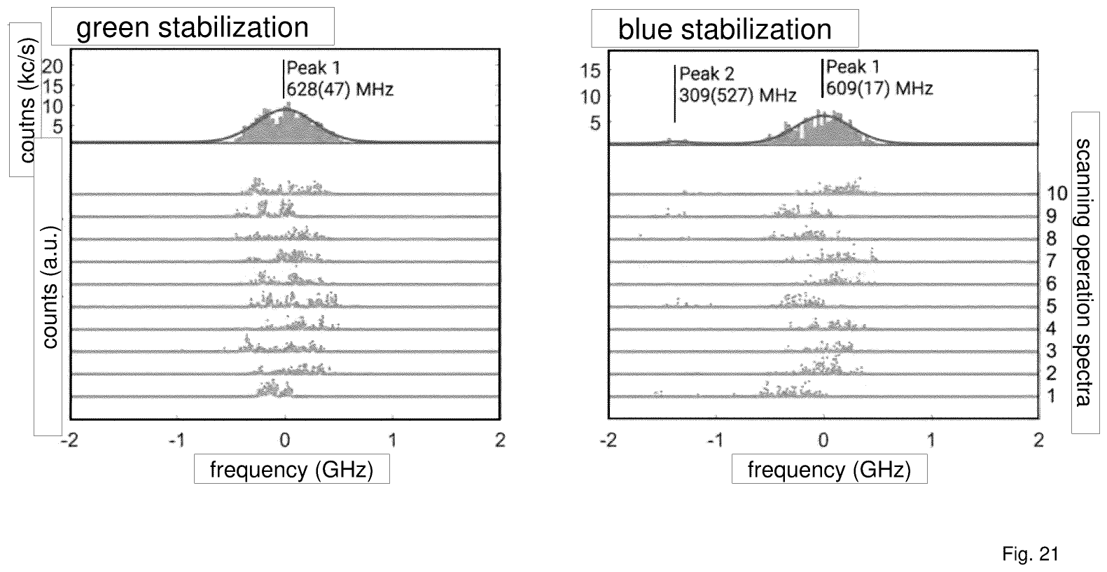

FIG. 21 shows plots of the photoluminescence excitation of the C-junction under different colored stabilization schemes of the emitter E2,

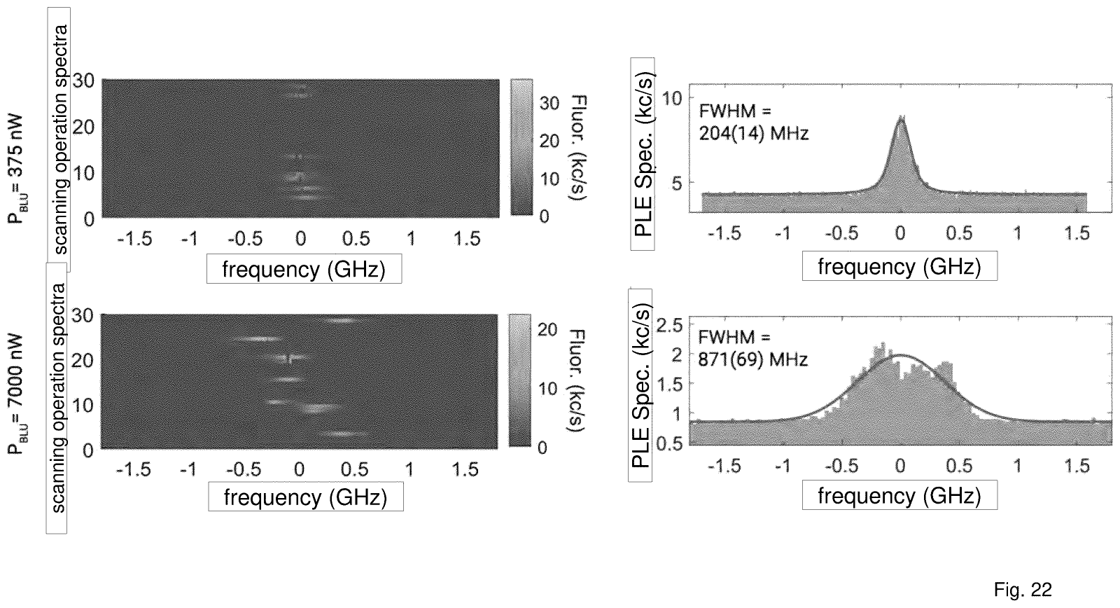

FIG. 22 shows plots of the comparison of different stabilization pulse powers, and

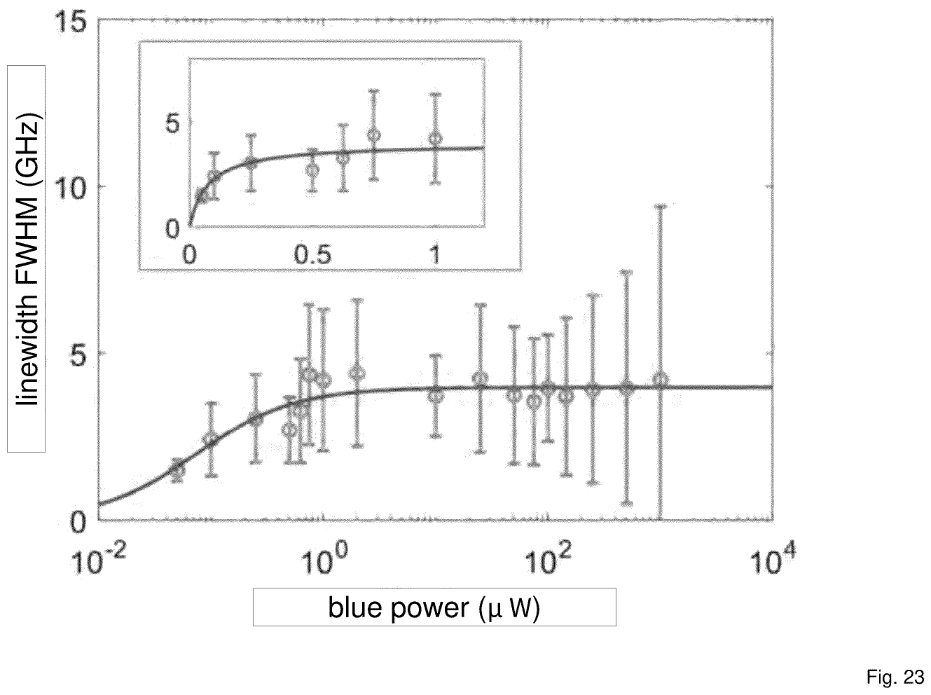

FIG. 23 shows a plot of the comparison of the different stabilization powers at the emitter E20.

The detection of individual charges plays a decisive role in the fundamental materials sciences and in the further development of classical and quantum high-power technologies which operate with low noise. However, it has so far not been possible to determine charges on the grating scale with time resolution. The development of an electrometer is presented which makes use of the spectroscopy of an optically active spin defect which is embedded in a solid-state material with a nonlinear Stark reaction. By using the approach in diamond (diamond lattice), a widely used platform for applications in quantum technology, it is possible to locate charge traps 12 (traps, multivacancies, double vacancies, vacancies, Vₙ, vacancies), to quantify their influence on the transport dynamics and the generation of noise, to analyze relevant material properties and to develop strategies for material optimization.

Free charge carriers such as electrons are essential components of the modern world. They enable devices such as smartphones and computers. Uncontrolled or undesired charges, on the other hand, can cause damage and reduce the performance of such devices. Prominent examples are the gate-oxide breakdown in flash memories and the charge noise at the nanoscopic level. Detection and quantification of desired and undesired charge carriers with electrometers is of great technological importance on the nanoscale.

Despite considerable progress, electrometers have so far not been able to measure elementary charges with time resolution with a resolution in the sub-nanometer range. However, precise localization and temporal analysis of charges at atomic lattice scales are becoming increasingly important. Thus, for example, the investigation of 2D-ferroelectric systems would greatly benefit from the use of a highly sensitive electrometer which could provide decisive insights into the unresolved fundamental aspects of its physical properties. Moreover, silicon transistors with a size of a few nanometers become increasingly more susceptible to charge-induced noise.

Applications of quantum technology in particular are challenging: In ion-based quantum computers, localized electronic states are suspected of causing decoherence due to movement heating; superconducting qubits suffer from defect-induced charge noise; in atom-like spin qubits in wide bandgap semiconductors, the charge noise leads to optical and spin decoherence, which considerably limits the development of quantum networks and sensors. The understanding of the underlying mechanisms of such platform-specific disadvantageous processes is a necessity in order to improve the performance and the field of application of electronic and photonic nanodevices, including open questions about decoherence processes, electron dynamics and material questions for the formation of lattice defects.

A device (electrometer, quantum electrometer) is presented which enables the detection of electric fields generated by individual and a plurality of elementary charges with a relative sensitivity of 10⁻⁷ and the localization of their relative position on the Ångström scale and at the same time offers a time-resolved access to the dynamics of individual charges, namely down to nanoseconds.

The electrometer consists of an optically active local probe 11 (probe, atom sensor probe, spectral sensor, sensor probe) sensitive to electric fields and a read-out unit 10 (cf. FIG. 1). The local probe 11 can be a negatively charged tin vacancy color center 21 (tin vacancy color center, SnV, SnV color center, SnV center) in a diamond (cf. FIG. 2), a solid-state defect with fluorescent junctions and a non-linear reaction to the electric field which is typical for defects in the D_{3d} point group. The optical transition energies depend directly on the local electric field via the DC-Stark effect Δₛₜₐᵣₖ=−μ_{ind}(Eₛ)Eₛ, where μ_{ind} is the induced dipole moment of the atomic defect and Eₛ is the sum of all static electric fields generated by surrounding charges and shifting the optical energies (FIG. 2).

The read-out unit 10 is for example a microscope (but not limited thereto), which is used for photoluminescence excitation spectroscopy at the local probe 11 and therefore does not require magnetic resonance methods. The measurement of the energy shift shows the magnitude of the electric field at the sensor probe 11 Eₛ via the DC-Stark shift

$${Δ}_{stark} = - Δμ {E}_{s} - \frac{1}{2} Δ α {E}_{s}^{2} - \frac{1}{3 !} Δ β {E}_{s}^{3} - \frac{1}{4 !} Δ γ {E}_{s}^{4} , \qquad ( 1 )$$

with Δμ as the change of the dipole moment and Δα, Δβ, and Δγ as differences between the higher-order polarizabilities. In contrast to non-inversion-symmetric configurations of color centers, such as the nitrogen vacancy center in diamond and the silicon vacancy center in silicon carbide, the negligible linear and strongly non-linear reaction due to the inversion symmetry, the sensor is usable for typical semiconductor dopant and defect densities. If Aa dominates and the observed Δₛₜₐᵣₖ originates from a localized elementary charge e at a distance r from the sensor 20, then the following applies:

$${Δ}_{Stark} ( r ) ∼ Δ α / {r}^{4} . \qquad ( 2 )$$

With decreasing distance of the charges from the sensor 20, increasingly larger spectral shifts occur. This property makes sensors 20 with an inversion center remarkably sensitive to charges in the immediate vicinity and insensitive to the background noise of electric fields.

The relative sensitivity of the electric field ˜10⁻⁷ (cf. FIG. 3) enables the readout of a spectral sensor with an exceptionally high spatial resolution, which extends down to a few μm even at charge trap densities (charge density, trap density, density) of up to a hundred ppm (cf. FIG. 4).

FIG. 2 shows a schematic illustration of the device for locating charge traps 12 in a crystal lattice (atomic lattice) by means of Stark shift. The local probe 20 is an optically active atomic defect with non-linearly strong-sensitive energy levels. The read-out unit 10 is a microscope with photoluminescence excitation spectroscopy. A close charge (neighboring charges, neighboring charge trap 12, near-range trap, near-range trap) shifts the optical transition from C₀ to Cₛ by Δs(r) as a function of its distance r. In addition, an ensemble of remote fluctuating charges (remote charge traps, far-range traps, far-range traps) broadens the signal from Cₛ to C_{s,b} as a function of the charge density ρₜᵣₐₚ. FIG. 3 shows the relative sensitivity |ΔE|/E to changes of the electric field as a function of the electric field Eₛ and the trap density ρₜᵣₐₚ. To the left of the dashed line, Stark shifts are not large enough to be resolved by the Rayleigh criterion. Larger field strengths correlate with a larger inhomogeneous broadening. In Eq. (1), Δμ=6.1×10⁻⁴ GHz/(MV/m)², Δα=−5.1×10⁻⁵ GHz/(MV/m)², Δβ=−5.5×10⁻⁸ GHz/(MV/m)³ and Δγ=−2.2×10⁻¹⁰ GHz/(MV/m)⁴ are assumed.

FIG. 4 shows the resolution of the sensor 20 in the determination of the distance of an elementary charge based on the distinction of two different charge traps 12 as a function of the charge trap density and the distances. The resolution was determined for a trap 12 with a variable distance r and a bias field corresponding to a trap distance of 0.8 nm. The dashed white lines indicate the inscribed resolution thresholds.

In the present exemplary embodiment, the local SnV probe 20 is stationary in a bulk crystal, but it could also be integrated into the tip of a scanning probe microscope 14 for position-dependent measurements which are well established in magnetometry, or into a nanodiamond 15 for integration with other materials or biological samples. Alternatively to the SnV, other D_{3d} symmetric defects such as the silicon or germanium vacancies and other inversion-symmetric defects in other materials, for example in silicon, could also be used as the local probe 11. To demonstrate the non-linear sensor principle, a single SnV generated by ion implantation and annealing is used.

### Determination of Charge Trap Positions on the Plane of the Atomic Lattice

The probe 20 and its environment are depicted in FIG. 5. To demonstrate the sensor capability, the temporally variable quasi-static electric field caused by the charging and neutralization of crystal defects in the surrounding lattice 13 under laser irradiation 22 is analyzed. On the basis of the recorded field strength in various configurations of the charge distribution, the position of the surrounding crystal defects can be extracted with a resolution on the grating scale.

If all the traps 12 are neutral, the total field at the position of the local probe 20 is zero and the optical transition of the SnV is undisturbed. A charged trap 12 induces an electric field \vec{Eₛ}, which strongly shifts the energy of the optical transition according to Eq. (1). If a single elementary charge is located in the vicinity of the probe 20, the C-junction is shifted by more than its own line width, which leads to a spectral jump (jumps, spectral jumps, charge state change, state change) (cf. FIG. 2). The magnitude of the spectral shift can be determined by comparison with the undisturbed case. The addition of both resonances in a spectrum leads to a unique optical fingerprint with two peaks.

In order to detect spectra 62 (cf. FIG. 6), the fluorescence of the sensor 20 is measured under photoluminescence excitation (PLE) with a narrow-band laser. The charge-induced electric field is extracted from the spectral shift. The knowledge of the local field and the use of the polarizability make it possible to determine the trap-probe distance.

For N charged traps 12 in the vicinity of the probe 20, the electric fields add to \vec{Eₛ} and the individual charges cannot be directly separated. To distinguish the 2^{N} charge states, the highly shifted PLE spectra 62 (photoluminescence emission spectra, PLE line scans, PLE line scans, scan, PLE scan, PLE spectrum) are repeatedly recorded. By means of the laser irradiation, the traps 12 are ionized and neutralized according to the random principle. By scanning a large number of configurations, complex trap distributions can be analyzed.

In addition to the closely spaced charges 12, which cause considerable spectral line shifts, the numerous randomly distributed traps in the remote environment also contribute to this. These remote traps have fluctuating charge states, which leads to a fluctuating electric field δ\vec{Eₛ}, which causes an inhomogeneous broadening. Consequently, the density of the charge traps ρₜᵣₐₚ within the lattice 13 can be determined by line width measurements. It is found that traps can be resolved with sub-nanometer resolution. For trap densities ρₜᵣₐₚ≈0.3 ppm, detection volumes of 150³ Å are possible. Fluctuating charge traps at larger distances contribute mainly to the inhomogeneous broadening.

In order to fully calibrate the electrometer, the non-linear reaction to external fields is taken into account, which causes a mutual dependence of the different external field components. Thus, for example, the effective Stark shift caused by two charges is not equal to their sum. This phenomenon enables a high resolution, but makes the analysis of the recorded fingerprints very complex. Therefore, a theoretical database with simulated spectra 60 is created for a multiplicity of discrete charge positions in the vicinity and remote trap densities using Eq. (1).

The complex experimental four-peak fingerprint from FIG. 6 can be analyzed quantitatively as follows. Experimentally determined polarizabilities are used. By comparing the experimental and simulated fingerprints, a plurality of possible trap configurations (charge trap configuration, charge state configuration, state configuration, charge trap state configuration) are found. Of these possible configurations, the most plausible is identified by specific physical considerations.

The most probable configuration of traps 12 in the vicinity consists of a permanent \vec{E_{bias}}, which is generated, for example, by a permanently ionized trap 12, and two additional traps 12 which cause spectral jumps. The spectral peaks (peaks) in FIG. 6 are assigned designations which are based on the charge state of the two additional traps 12 in the vicinity ◯◯, ◯⊙, ⊙◯, ⊙⊙, wherein ◯ corresponds to an uncharged trap (neutral charge trap) and ⊙ to a charged trap (ionized charge trap). Subsequently, the position of these charge traps 12 up to an azimuthal angle is determined by means of Monte Carlo simulations. The relative Stark shifts corresponding to the distances of the neighboring traps r₁=8(1) Å,r₂=11(2) Å, r₃=26(3) Å (FIG. 7) and a charge trap density of 74(22) ppm remote from the local probe are extracted.

FIG. 5 shows a schematic illustration of a crystal lattice 13 having a tin vacancy (SnV) 21 and lattice defects. The charges localized in this case 12 cause a Stark shift of the energy levels of the atom sensor probe 20. From very close to far, the spectral effect of an elementary charge can be categorized as follows: a >30 GHz spectral shift which can be detected by photoluminescence spectroscopy, a ^{˜}GHz shift which can be detected by photoluminescence excitation spectroscopy (PLE) and inhomogeneous broadening which can be detected by PLE. Charges in the very far range have negligible effects.

FIG. 6 shows a plot of the integrated spectrum 61 (multimodal spectrum) and of a simulated spectrum 60 with assignment of the peaks to the charge trap states (trap states, state) and a plot of the photoluminescence emission spectra 62 as a function of the Stark shift. At the top of FIG. 6, an integrated multimodal PLE spectrum 61 is shown, recorded with the SnV sensor 20 (blue) and modeled with Monte Carlo simulations (integrated spectrum 61 with error bars which represent the statistical standard deviation) in order to determine a close charge trap configuration (states above the peaks, ⊙ and ◯ stand for ionized and neutral traps 12, respectively) and the surrounding charge density. At the bottom of FIG. 6, time-resolved photoluminescence emission spectra 62 are illustrated and also an SnV level scheme.

FIG. 7 shows an illustration of the relative positions of the charge traps 12 and their probability distribution with respect to the SnV probe 20 and a table with indication of the charge trap states and the position of the identified charge traps 12. On the left side, identified charge trap configurations, their relative (optimal) positions and their probability distribution with respect to the SnV probe 20 are illustrated. The distributions resemble a donut shape on account of the direction-independent calibration of the sensor 20. On the right side, a diagram with indication of the charge trap states and the position of the identified traps 12 is shown.

### Dynamics of the Charge

In order to identify the position of charge traps 12, accumulated spectral fingerprints were used which reflect the integrated spectrum 61 for the total set of charge states u_{c}={◯◯,◯⊙,⊙◯,⊙⊙,Snv⁻²}, including the dark state SnV⁻². The comparison of individual readout events of the electrometer, i.e. individual PLE line scans between different charge configurations within Uc enables the access to the time-resolved charge transfer dynamics.

The charge state changes are interpreted with a simplified charge transfer image (cf. FIG. 8): charge traps 12 which are later identified as multivacancy complexes Vₙ can be ionized under laser illumination by two different processes: negative charge which occurs when the trap 12 traps an electron transported out of the valence band and leaves a positively charged hole in the band; and positive charge when an electron is transported out of the trap 12 into the conduction band. The created holes and the transported electrons then diffuse and recombine with other charge traps 12, leading to an overall charge neutral environment. The event OO→O⊙ is designated as ionization and the reverse case ◯⊙→◯◯ is designated as neutralization event. The image of the charge transfer coincides with the time-resolved correlation measurements carried out when it is assumed that charge events are triggered by single photon processes.

To characterize the local charge environment and dynamics, the transition probabilities 92 of the charge states p(i→j) and the conditional transfer rates (jump rate 93, state change rate, charge state change rate) Γ_{ct}(i→j) are introduced between charge states i and j of the proximity traps 12, wherein i,j∈U_{c}·p(i→j) and Γ_{ct}(i→j) are extracted from histograms 90 which have been established on the basis of the charge transfer events and the intervals between them (cf. FIG. 9). Furthermore, the lifetimes of each configuration are defined as τ(i).

FIG. 8 shows a schematic illustration for SnV of the ionized and neutral lattice defects (Vx_{,y}) in the bandgap. Ionization occurs when either an electron is transported out of the valence band into the charge trap 12 or an electron is transported out of the trap into the conduction band by an illumination field. Neutralization occurs when the trap 12 traps either a hole from the valence band or an electron from the conduction band.

FIG. 9 shows example histograms 90 which show how long the charge remains in one charge trap state until it changes into another and a table with jump probabilities 92 p(i→j) and jump rates 93 Γ_{ct}(i→j) to the corresponding spectral jumps 91 i→j. The example histograms 90 show how long the resonance remains in one charge state until it changes into another. The data is fitted to a Poisson distribution to estimate an average time. The temporal values can be determined from the sensor data in FIG. 6. The experiment is performed under 0.5 nW 619 nm light, with a 2 μW (CW power) blue 450 nm pulse with a duration of 4 ms being applied between the line scans. p(i→j) and Γ_{ct}(i→j) represent conditional spectral jump probabilities 92 and rates 93, respectively, with i, j being the initial and final charge state configurations, respectively. Missing rates are due to insufficient data points. Γₛ is the sampling rate. The uncertainties are estimated from the overlap of the individual peaks for p(i→j) and the 95% confidence intervals extracted from the fittings for Γ_{ct}(i→j).

The analysis is started with the quantification of the smallest jump probabilities 92 p(i→j). The occurrence of a charge exchange event taking into account the current line scan time of 5 seconds, given by p(◯⊙→⊙◯)=0.03(1), indicates an unlikely direct transfer between the two closely spaced traps 12. In addition, the occurrence of a two-trap charge event p(◯◯→⊙⊙)=0.03(1) is also unlikely, which shows that these events are not correlated.

Further, the relationship between the re-initialization of the bright SnV charge state SnV⁻²→SnV⁻¹ and the charge states of the trap 12. The probabilities p(SnV⁻²→◯⊙)=0.61(12) and p(SnV⁻²→◯◯)=0.38(9) are close to the corresponding peak intensities in the spectrum 61 (0.63(5) and 0.31(3) respectively), which can indicate that the trap states are not correlated with the charge state of the SnV.

In the following, the ionization and neutralization rates for an individual trap 12 are compared, Σ_{X=◯,⊙}Γ_{ct}(◯X→⊙X)/2=0.075(1) Hz and Σ_{X=◯,⊙}Γ_{ct}(⊙X→◯X)/2>>Γₛ=0.2 Hz respectively, wherein Γₛ is the scan rate. The more than 3-fold higher ionization rate may reflect the different physical mechanism compared to neutralization. The ionization rates of the other trap 12 change abruptly with time: for the line scans 0-250Γ_{ct}(◯◯→◯⊙)=0.07(2) Hz and 250-500Γ_{ct}(◯◯→◯⊙)>>Γₛ=0.2 Hz. At the neutralization rate, the trend is reversed. This change in the rates 93 is attributed to discrete changes in the trap environment. Moreover, the different ionization rates, Γ_{ct}{(◯◯→◯⊙})=0.09(1) Hz and Γ_{ct}(◯◯→⊙◯)=0.19(4) Hz, observed under the same illumination laser field, either indicate large variations in the local electrostatic potentials in a ˜1-nm range that change the charge dynamics, or indicate the presence of multiple charge trap types. By means of further investigations, a distinction could be made between the different Vₙ.

Furthermore, the overall lifetime of the charge states τ(i), which provides an indication for experiments requiring spectral stability, is determined and interpreted. τ(◯⊙)=2.3(1) s and τ(◯◯)=4(1) s are found, which approximately correspond to the duration of a line scan. The measurement method comprises a blue 445-nm charge initialization pulse between each line scan, accompanied by a continuous orange 619-nm laser illumination. These time scales show that the blue laser is the primary driver for changes of the charge trap states (FIG. 20), which indicates that the stability of the trap states can be maintained during optical operations that resonate with SnV junctions. Since the trap states are much longer stable than the measured SnV ionization time of 50 ms and the spin coherence time of about 1 ms, although not deterministic, the emitter can still act as an optically coherent spin-photon interface.

### Evaluation of Spectral Scattering

The spectral dynamics induced by the charge transfer are extremely disadvantageous for applications in quantum technology. Spectral diffusion, a term that indicates the probabilistic nature of the observed spectral dynamics, leads to optical decoherence, which leads to reduced entanglement fidelity in quantum network nodes.

Knowing the non-linear susceptibility of the quantum electrometer to charge noise, predictions are now made about how a particular charge distribution influences the spectral properties of a color center. Based on the model, an overview is given of the inhomogeneous broadening caused by a particular charge trap density ρₜᵣₐₚ. The details of the calculation are described in the sections below.

First, the bulk case (cf. FIG. 10) is considered and surface charge traps ρₜᵣₐₚ^{s} are analyzed for two different surface geometries, planar and cylindrical. It is found that an implantation depth of d>21 nm and a cylinder with a radius of r>45 nm ensure that the surface charges do not degrade the spectral properties of a SnV color center with a line width broadening of less than 1%. Such broadening leads to a 90% interference visibility and more than 87% entanglement fidelity. Similar estimations can be carried out for each defect with known polarizability. Control measurements for the spectral diffusion as a function of the illumination field are contained in the additional materials.

On account of the estimated minimal harmful distances, SnVs and similar color centers are well suited for integration in nanostructures which increase the photon collection efficiency and provide tailor-made emission properties for quantum information applications via the Purcell effect.

In FIG. 10, plots of the inhomogeneous broadening of the SnV zero phonone line on account of bulk and surface charges are shown. The inhomogeneous broadening of a SnV line with a lifetime-limited line width of 35 MHz is shown as a function of ρₜᵣₐₚ in units of ppm in a bulk diamond. The brightnesses in the plots indicate the line width distribution. The mean value and the variance of the distribution are represented by the white points and the error bars. The inhomogeneous broadening as a function of the distance of a SnV to a planar surface and the surface trap density ρₜᵣₐₚ^{s} is defined as the proportion of the surface lattice sites. The dashed lines show the threshold value of 1% and 10% of the broadening in comparison with the lifetime-limited line width of 35 MHz. The inhomogeneous broadening of a SnV which is located centrally in a cylinder with radius r is a function of ρₜᵣₐₚ^{s}. The dashed lines denote 1% and 10% broadening respectively.

### Identification of Material Properties: Double Vacancy Formation

Based on the ability of the electrometer to quantify the charge trap density, the investigation of the material properties is extended and the sensor data are combined with additional simulations. In particular, the physical origin of charge traps 12 in the implanted diamond is determined. For a sample with less than 1 ppb of nitrogen and boron and even lower lattice defect concentrations, the estimated charge trap density of 74(22) ppm must originate from the damage by the Sn ion implantation and the subsequent annealing process. The ion implantation generates Frenkel pairs: a pair of a single vacancy V₁ and a dislocated interstitial carbon atom. During annealing, Vₙ becomes mobile and can form vacancy complexes, a process which is not well understood and is an active field of research (cf. FIG. 11).

Here, the V₁ to double vacancy V₂ conversion yield is estimated by means of a kinetic Monte Carlo simulation in combination with a simple stochastic diffusion model.

The density V₂ is considered as a proxy for higher-order vacancy complexes Vₙ. Annealing to up to 1100° C. primarily converts V₂ into V₃ and V₄. In fact, wavelength-dependent spectral diffusion and jumps (cf. FIG. 21) are observed, which indicate different ionization energies of the multiple trap species. The estimated density of V₂ both as an approximation to an order of magnitude and as an upper limit for the total density of the charge trap 12. ρ_{V}_{₂}=40.0(2.1) ppm is compared with the experimentally estimated trap density of Σ_{Exp}=74.1(22.5) ppm. On account of the charge neutrality, the total charge density ρ_{Sim}=would be twice the density of V₂ with ρ_{Sim}=ρ_{V}_{₂}×2=80.0(4.2) ppm. The small deviation is attributed to a reduction in the density of Vₙ in comparison with the V₂ estimation.

Understanding the origin of the charge traps 12 also provides a clear way of how to optically generate noise-free group 4 vacancy defects in the diamond. Single-peak fingerprints, which indicate a low Vₙ density, are more often annealed in high pressure and high temperature (HPHT) annealed samples at 2000° C., which is consistent with electron spin resonance measurements.

Spectral jumps have already been observed for group IV vacancy defects. A comparison of the Vₙ density for the atomic species Si, Ge and Sn and different implantation energies (FIG. 12) shows that the Si implantation leads to the lowest V₂ density. This observation is consistent with the more frequent reports of spectrally stable SiV in comparison with SnV, which can now be explained with the analysis that heavier ions cause increasing Vₙ densities.

FIG. 11 shows a schematic illustration of a formation of double charge traps (V₂) in the crystal lattice 13 during an annealing process. A spatial distribution of the single vacancies (V₁) generated by 400 keV Sn implantation is shown, which are predicted by SRIM simulations.

Furthermore, the formation of V₂ during annealing at 800° C. is shown. At higher temperatures, V₁ begins to diffuse. Then, V₁ either moves to the interfaces, recombines with interstitial carbons or forms V₂. In addition, the distribution of V₁ and V₂ is shown, which are distributed in the vicinity of the damage channel caused by the Sn implantation.

FIG. 12 shows plots of the simulated densities of the double charge traps V₂ as a function of the single charge traps V₁ implantation yield (% of the participating V₁, estimated by SRIM simulations) for three different species: tin, germanium and silicon. A lower yield of V₁ is attributed to the recombination with interstitial carbons. The implantation energies are selected such that an average implantation depth of 100 nm is achieved. Densities of V₂ for 100 keV implantation energy are shown. The error bands shown represent the statistical standard deviation.

### Overview of Monte Carlo Simulation

In the following, an overview is given of the general methodology for the simulation of individual and multimodal spectra 60 (FIG. 6). The simulations begin with the uniform distribution of charge traps 12 within a certain volume or surface. In the case of multimodal spectra 61, such as that illustrated in FIG. 6, the distribution of the charge traps 12 is divided into two categories: near-range traps 12 and far-range traps. Proximity traps 12 are positioned at fixed locations, while far-range traps are distributed with a fixed density within a predetermined volume. The SnV⁻¹ probe 20 is always at the origin of the coordinate space.

As soon as a spatial trap configuration is created, a single iteration of the Monte Carlo simulation can be carried out. It consists in assigning charges to the trap locations (charging of the traps 12). A fixed number of charges 12 is distributed under the assumption of the charge neutrality: −e+eΣᵢ qᵢ=0 with elementary charge e and charge state qᵢ∈{−1,0,+1}. The field strength at the location of the SnV⁻¹ then becomes:

$$\vec{E} = {\sum }_{i} \vec{E} ( {q}_{i} . \vec{{r}_{i}} ) , \qquad ( 3 )$$

where \vec{r}ᵢ is the position of a trap 12 and \vec{E}(qᵢ,\vec{r}ᵢ) is the electric field of a point charge in the medium, which is selected such that it adequately reflects the boundary conditions for the solution of the Maxwell equations. The non-linear Stark shift Δₛₜₐᵣₖ corresponding to the magnitude of the field \vec{E}(q,\vec{r}ᵢ) is calculated with Eq. 1, where Eₛ=|Eₛ| and the parameters Δμ=6.1×10⁻⁴ GHz/(MV/m)², Δα=−5.1×10⁻⁵ GHz/(MV/m)², Δβ=−5.5× 10⁻⁸ GHz/(MV/m)³ and Δγ=−2.2×10⁻¹⁰ GHz/(MV/m)⁴. Unless expressly stated otherwise, the method is repeated 1000 times and the following applies for the spectrum 61 corresponding to the distribution of the Stark shifts:

$$S ( ω ) = \frac{1}{N} {\sum }_{n} {L}_{γ} ( ω - {Δ}_{Stark , n} ) , \qquad ( 4 )$$

where N is a normalization constant (max S(ω)=1), n is the simulation step index and L_{γ}(ω) is a Lorentz line profile with full width at half maximum γ=35 MHz corresponding to the lifetime-limited line width of the SnV⁻¹. It is assumed that there is neither an additional power broadening nor a reduction in lifetime due to Purcell gain.

### Relative Sensitivity to Electric Fields

The sensitivity of the relative electric field δϵ=ΔE/Eₛ at a given ρₜᵣₐₚ can be calculated by resolving ΔE according to the smallest spectral shift Δ_{Stark} according to a modified Rayleigh criterion as described below.

ΔE is calculated in a two-stage method: First, the expected inhomogeneously broadened line width is simulated in the presence of an electric field \vec{Eₛ} (see FIG. 13) which is generated either by a charged near trap 12 or by a non-neutral charge state of the total spatial trap configuration. The total field at the sensor position can be divided into two components: \vec{E}=\vec{Eₛ}+δ\vec{Eₛ}, where δ\vec{Eₛ} is a fluctuating electric field generated by the varying charge states of the remote trap configuration.

In FIG. 13, a plot of the inhomogeneous broadening as a function of the local bias field Eₛ is shown. The line width increases with increasing Eₛ or ρₜᵣₐₚ.

The average value of the non-linear Stark shift is given by <Δₛₜₐᵣₖ>=−Δα(Eₛ²+σ²). Its variance is σ_{Δ}_{_{Stark}}=Δα²(4Eₛ²σ²+2σ⁴) (assuming that δ\vec{Eₛ} is normally distributed with variance σ). The expressions show that a field causes both a discrete spectral shift and a quasi-permanent dipole moment, which leads to an inhomogeneous broadening of the lines as a function of the magnitudes Eₛ and σ.

In the second step, ΔE at a given ρₜᵣₐₚ is calculated with the aid of a modified Rayleigh criterion: Two spectral peaks which originate from different fields Eₛ and Eₛ′ are considered separable if the sum of the two individually normalized line shapes, which result from \vec{E}=\vec{Eₛ}+δ\vec{Eₛ} und \vec{E}=\vec{Eₛ′}+δ\vec{Eₛ}, have a contrast of at least 26.3% between their local maxima.

\vec{Eₛ}=(0.0,Eₛ) is selected for FIG. 7. To determine the (Δ_{Stark}) and the inhomogeneously broadened line width, a Monte Carlo simulation is used, as described in the simulation overview. The traps which generate δ\vec{Eₛ} were placed with a fixed density ρₜᵣₐₚ in a conical volume z>0 with an opening angle of 45° which mimics the anisotropic distribution of the traps generated by implantation and annealing (cf. e.g. FIGS. 5 and 6). The conical volume was capped at z=30 nm. A spherical volume of 2.5 nm was left free of traps 12 in order to reduce the occurrence of exaggerated multimodal spectral features.

The averaged line widths required for FIG. 3 are calculated with γ_{FWHM}=aσₕₒₘ+(bσₕₒₘ2+σᵢₙₕₒₘ²), where σₕₒₘ und σᵢₙₕₒₘ is the full width at half maximum of the Lorentz and Gaussian contribution to the Voigt profile and a=0.5346, b=0.2166. In total, the Gaussian and Lorentz components of 100 different spatial trap configurations are averaged at a given ρₜᵣₐₚ. For each ρₜᵣₐₚ, 2500 randomly generated charge states are taken to simulate a single spectrum 60. The averaged spectral profiles corresponding to \vec{E}=\vec{Eₛ}+δ\vec{Eₛ} and \vec{E′}=\vec{Eₛ′}+δ\vec{Eₛ} are then used to determine Δ\vec{Eₛ}=|Eₛ−Eₛ′| using the Rayleigh criterion.

Finally, the relative sensitivity illustrated in FIG. 3 is calculated by dividing δϵ=ΔE/Eₛ at a given ρₜᵣₐₚ.

### Resolution

To determine the spatial resolution Δᵣ=|\vec{r}−\vec{r′}|, where \vec{r} and \vec{r}′ are two different positions of point-shaped charges, the same calculation is carried out as for the relative sensitivity of the electric field. However, it is additionally assumed that the charges generate electric fields:

$$\vec{E} ( q , \vec{r} ) = \frac{{q}_{i}}{4 {πϵ}_{0} {ϵ}_{r}} \frac{\vec{r}}{{r}^{3}} , \qquad ( 5 )$$

where ϵ₀ is the permittivity of the vacuum and ϵᵣ=5.5 is the relative dielectric constant of diamond. The use of the bulk expression and the neglect of surface contributions is justified on account of the dimensions of the column, r>40 nm (FIG. 4), when the SnV is located on the axis of symmetry of the column. FIG. 4 shows the resolution of the sensor 20 in the presence of a constant static field Er, which is generated by a negatively charged trap 12 at a fixed location, \vec{r}₀=(0; 0; 0.8) nm. As described in the previous section, FIG. 4 was created in a two-stage method: First, the expected spectral profiles were calculated for a given ρₜᵣₐₚ and \vec{E}=\vec{E}(−1,\vec{r₀})+\vec{E}(−1,\vec{r₁})+δ\vec{Eₛ}. Then, the resolution was calculated using the Rayleigh criterion.

The location vector \vec{r}₁=(0,0,d) is placed in a line with \vec{r}₀. The averaged profiles are then used to determine the smallest resolvable distance Δᵣ=|\vec{r}−\vec{r′}| from the spectral profiles, with the fields \vec{E_{bias}}=\vec{E}(−1,\vec{r₀})+\vec{E}(−1,\vec{r₁})+δ\vec{Eₛ} and \vec{E_{bias}}=\vec{E}(−1,\vec{r₀})+\vec{E}(−1,\vec{r₁})+δ\vec{Eₛ}.

### Multimodal Spectra

The most probable trap configuration is determined in three steps. Firstly, the spectral positions of the (in the present case) four peaks observed in the measured multimodal spectrum 61 are determined in order to determine the near traps 12 which produce the Stark shifts observed in the experiment. Next, the predetermined positions of the near traps 12 are fine-tuned by means of an optimization method which makes use of a comprehensive collection of simulated spectra 60. Finally, by means of an objective function (χ²-test), the most probable near trap configuration is determined by comparing the simulated spectra 60 with the experimental observations.

### Modeling of Annealing

A kinetic Monte Carlo simulation of the annealing process was carried out, in which an initial distribution of the single vacancies was calculated with SRIM for a particular set of implantation parameters. Subsequently, a spatial distribution of the double vacancies was calculated by randomly migrating the single vacancies on the fcc diamond lattice until they encountered another single vacancy and formed a double vacancy.

### Sample

The sample used (E001) is an electronic diamond (element 6) grown by chemical vapor deposition (CVD). The sample was first purified in a boiling triacid solution (H₂SO₄:HNO₃:HClO₄, 1:1:1) and then etched in Cl₂/He and O/CF₂₄ to remove organic impurities and structural defects from the surface. Subsequently, Sn (spin-0) ions with a fluence of 5×10¹⁰ Atomen cm⁻² and an implantation energy of 400 keV were implanted in the diamond, corresponding to a penetration depth of 100 nm, as estimated by SRIM simulations. The formation of the SnV color centers was finally carried out by annealing the diamond at a temperature of 1050° C. for about 12 hours in vacuum (pressure 7.5×10⁻⁸ mbar).

The nanopillars were produced by a combination of electron beam lithography and plasma etching. Initially, 200 nm of Si₃N₄ was deposited on the surface of the diamond in an inductively coupled plasma (ICP) CVD system. After coating the sample with 300 nm of electrosensitive resist (ZEP520A), columns with nominal diameters of 180 nm to 340 nm were exposed by means of electron beam lithography in steps of 40 nm. After development, the pattern on the Si₃N₄ layer was transferred into the SiN layer by a reactive ion etching plasma (RIE) (10 sccm CF₄, RF power=100 W, P=1 Pa) and subsequently etched in the diamond in an ICP process in O₂ plasma (80 sccm, ICP power=750 W, RF power=200 W, P=0.3 Pa). The remaining nitride layer was finally dissolved in a solution of buffered HF.

### Optical Construction and Experimental Details

The sample is cooled to 4 K in a closed-loop helium cryostat (Montana s50). A confocal scanning microscope is used to localize and optically address nanopillars with SnV. The SnV is initialized with a blue diode laser at 450 nm (Thorlabs LP450-SF15 or Hübner Cobolt 06-MLD). Non-resonant measurements are carried out with a green diode laser at 520 nm (DLnsec). The PLE spectra were measured with a spectrometer (Princeton Instruments HR500) and a CCD camera (Princeton Instruments Excelon ProEM: 400BX3). The photons collected by the cryogenic construction are coupled into a fiber and counted via avalanche photodiodes (Excelitas SPCM-AQ4C or SPCM-AQRH). The experiments are controlled with the software package Qudi.

A highly tunable laser at 619 nm (Sirah Matisse, DCM in EPL/EG solution) and an SHG laser source (TOPTICA SHG DLC PRO) are used for PLE scans. In this case, the frequency of the resonant excitation laser is scanned over the C-junction of an SnV center and the phonon side band of the fluorescence is captured. The analyzed measurement (FIG. 6) was recorded at P=0.5˜nW<<Pₛₐₜ in order to minimize the power broadening and the SnV ionization. Between each line scan, 4 ms were carried out with 2 μW (average CW power) blue laser irradiation.

### Temporal Analysis of the Sensor Data

As described, emitters with inversion symmetry can be used to examine aspects of the charge dynamics in the vicinity of the emitter. Details of the data analysis of the long-term PLE scans for estimating the lifetime of the charge configuration in the vicinity and the switching rates are explained below.

Wave meter correction: During the scanning, the frequency of the laser is controlled by applying an external voltage signal. The laser frequency is monitored via a pickoff path directed onto a wave meter. The PLE spectra 62 are first recorded as voltages and fluorescence signals. The voltages can then be converted into frequencies by adjusting the time stamps. All non-linear frequency changes occurring during the scan are thus taken into account.

Binning: Individual scans are mapped onto a frequency axis by selecting an individual line scan and subsequent frequency binning. If a plurality of data points fall into the same bin, they are averaged. If a bin remains empty, the average of the previous and the next bin is used.

Histogramming of scans: The binned scans are summed and normalized to create histograms for PLE spectra 62.

Identification of the configuration: A peak finder algorithm (MATLAB: findpeaks) is used to identify the frequencies of the (in the present case) four peaks. These peaks are then labeled and used for averaging the spectral position corresponding to a specific charge configuration of near traps 12.

Configuration ranges: The state configurations are separated by assigning a spectral range to each central peak position. These ranges can result from half of the spectral distance between two neighboring peaks.

Scanwise peak recognition: For each individual scan, the same peak finder algorithm is used to find peaks.

Scanwise identification of the configuration: The identified peaks are then assigned to a charge state configuration on the basis of their central frequencies.

Determination of the brightness durations: A brightness duration is determined by the time span in which a peak value is associated with the same charge configuration until a change occurs. Each brightness duration is recorded together with the changes of the charge state configuration.

Histogramming of the brightness durations: The brightness durations are combined into histograms 90 according to the frequency with which they were observed, in order to extract averaged lifetimes and switching rates 93.

Probability 92 of a charge state change p(i→j): The frequency with which a spectral jump 91 from one charge state i to another j has occurred is recorded. It is then normalized to the total number of jumps from the configuration i in order to obtain a probability. There are two factors that can limit the quantification of the uncertainties. First, jump events depend on the individual identification of the peak positions per line. The implemented peak finder algorithm localizes the maximum of a line for each scan. On account of the spectral scattering, it is not possible to fit each individual line and to extract a central frequency uncertainty. Secondly, there are overlaps of individual spectral peaks in the integrated spectrum 61 in FIG. 6. Although a truncation position in the middle of the peaks has been selected, some of the identified peaks could actually belong to the tail of the neighboring spectral peak instead of to the identified position. Therefore, a total uncertainty factor is assigned by calculating the overlap of the individual integrated fittings of the individual peaks. Subsequently, these factors are multiplied by the extracted probabilities 92.

Poisson fitting: The histograms 90 are converted into probability densities and then fitted to a Poisson distribution. After the fitting, the histogram 90 and the fitting are scaled back to the original occurrences. The brightness durations are then converted into real time units by the duration of an individual scan.

Lifetime τ(i) and determination of the conditional spectral jump rate 93 Γ_{ct}(i→j): The mean values of the poisson distribution fittings and their uncertainties are given as lifetimes of the proximity charge configurations or their reversal as state change rates between the configurations.

### Simulation Details

### Multimodal Spectra

In the following, the simulation of the multimodal spectrum is illustrated in detail in FIG. 6. It is described that there is a spatial trap configuration which can reproduce the experimental data in FIG. 6.

The process for determining the most probable trap configuration can be divided into three main steps. First, the four peaks observed in the measured multimodal spectrum 61 are used in order to determine the positions of near traps 12 which produce Stark shifts which correspond to the experimental observations. This first step provides a rough estimation of the positions of the near traps 12. Next, an optimization method is applied in order to fine-tune the predetermined positions of the near traps 12. By optimizing the relevant parameters, a comprehensive collection of simulated spectra 60 is produced. Finally, by means of the objective function (χ² test) which was used during the optimization method, the large data set of simulated spectra 60 is analyzed in order to determine the most probable configuration of the near traps 12. This objective function serves as a measure of the correspondence between the simulated spectra 60 and the experimental observations. By comparing the calculated spectra 60 with the measured data, the configuration which best corresponds to the experimental results can be determined. In the following, each individual step is described in detail.

The four peaks of the measured spectrum 61 in FIG. 6 are used as a reference in order to estimate the position of a charged near trap 12 relative to the SnV by means of the following equation:

$${Δ}_{stark} = - Δμ {E}_{s} - \frac{1}{2} Δ α {E}_{s}^{2} - \frac{1}{3 !} Δ β {E}_{s}^{3} - \frac{1}{4 !} Δ γ {E}_{s}^{4} . \qquad ( S 1 )$$

It is assumed in the present case that the scenario with three traps 12 contributing to the multimodal spectrum 61 is most probable. The trap 12 which is at \vec{r}₂=(0,0,r₂) is assumed as permanently charged. The charge state of the two other traps 12 is then given by {◯◯,◯⊙, ⊙◯,⊙⊙}, wherein the left circle corresponds to a trap 12 at the position n and the right circle corresponds to a trap 12 at the position \vec{r}₃. An empty circle corresponds to a neutral trap 12, while a filled circle indicates a trap 12 with negative charge. The peaks corresponding to each charge state are illustrated in FIG. 6. The negative charge which is located at a distance \vec{r}₂ increases the reaction of the SnV to remote charges and generates the observed inhomogeneous broadening. The choice \vec{r}₂=(0,0,r₂) is not necessarily generally valid, but it can be assumed on account of the anisotropy to be expected by the implantation method. Furthermore, the inclusion of the position \vec{r}₂ with two further degrees of freedom would increase the free parameter space.

The arrangement of the three near traps is limited to one plane, whereby the complexity of the problem is further reduced. The starting positions \vec{r}₁, \vec{r}₂, \vec{r}₃ are approximated by solving the following equation system:

$${Δ}_{○○} = - \frac{Δ α}{2} {E ( - 1 , {\vec{r}}_{2} )}^{2} \qquad ( S2 )$$

$${Δ}_{○ ⊙} = - {\frac{Δ α}{2} [ E ( - 1 , {\vec{r}}_{2} ) + E ( - 1 , {\vec{r}}_{1} ) ]}^{2} \qquad ( S3 )$$

$${Δ}_{{⊙}_{○}} = - {\frac{Δ α}{2} [ E ( - 1 , {\vec{r}}_{2} ) + E ( - 1 , {\vec{r}}_{3} ) ]}^{2} \qquad ( S4 )$$

$${Δ}_{⊙ ⊙} = - {\frac{Δ α}{2} [ E ( - 1 , {\vec{r}}_{2} ) + E ( - 1 , {\vec{r}}_{1} ) + E ( - 1 , {\vec{r}}_{3} ) ]}^{2} . \qquad ( S5 )$$

The positions are parameterized according to:

$${\vec{r}}_{1} = {r}_{1} [ cos ( {θ}_{1} ) , 0 , sin ( {θ}_{1} ) ] \qquad ( S6 )$$

$${\vec{r}}_{3} = {r}_{3} [ cos ( {θ}_{3} ) , 0 , sin ( {θ}_{3} ) ] . \qquad ( S7 )$$

The above equations can be resolved according to r₁(θ₁), r₃(θ₁) and θ₃(θ₁). The relative shifts Δ_{◯◯}, Δ_{◯⊙}, Δ_{⊙◯}, Δ_{⊙⊙} are estimated from the central peak positions by means of a fitting method, wherein the integrated spectrum in FIG. 6 is simultaneously fitted with four Voigt profiles.

The fine tuning of the near trap positions in the second step takes place, in turn, by means of a Monte Carlo simulation in combination with an optimization method. For the optimization method, the remote traps are randomly distributed in a conical volume z>0 nm with an opening angle of 45° with a fixed density ρₜᵣₐₚ in order to imitate the non-isotropic distribution of the traps which is to be expected in the case of implantation damage. The volume is capped at 30 nm. A volume r_{q}<2.5 nm is used for the arrangement of the near charge traps 12. It is assumed that a charged trap leads to the total field

$$\vec{E} = {\sum }_{i} \vec{E} ( {q}_{i} , \vec{{r}_{i}} ) , \qquad ( S8 )$$

with

$$\vec{E} ( {q}_{i} , \vec{r} ) = \frac{{q}_{i}}{4 {πϵ}_{0} {ϵ}_{r}} \frac{\vec{r}}{{r}^{3}} , \qquad ( S9 )$$

where e is the elementary charge and qᵢ is a charge state with qᵢ∈{−1,0,+1}, co is the dielectric constant of the vacuum and ϵᵣ=5.5 is the relative dielectric constant of diamond.

For each choice of ρₜᵣₐₚ, r₂ and θ₁, a Monte Carlo simulation of the spectral fingerprint is carried out.

In order to adequately take into account the charge state of the near traps 12, they are charged with a probability pᵢ corresponding to the relative peak heights in each individual simulation step. The following probabilities pᵢ were used: p_{⊙⊙}=0.041, p_{⊙◯}=0.017, p_{◯⊙}=0.63 and P_{◯◯}=0.31.

The optimization of the trap positions for given ρₜᵣₐₚ, τ₂ and θ₁ is carried out by minimizing the χ² function with:

$${\sum }_{i} χ ( θ , i ) = {\sum }_{n = 0 , i}^{N} \frac{{[ {O}_{n} ( θ , i ) - {E}_{n} , i ]}^{2}}{{E}_{n}} , \qquad ( S10 )$$

by means of the algorithm for the simplicial homology global optimization (shgo). An implementation of the shgo algorithm is used, which is provided by the Python library SciPy. In Eq. (S10), the following applies θ=[a,b,p], wherein a, b fine tune as follows: r₁′=ar₁ and r₃′=br₃.

The spectrum is divided into three parts, which are designated by i∈{◯◯,◯⊙,⊙◯+⊙⊙}. For each part, the respective simple and double Voigt profile fits are used for comparison with the simulated spectra 60 using Eq. (S10). In Eq. (S10), E_{n,i} are the expected counts in the nth bin, which has been determined by binning the (normalized) single and double Voigt profiles which have been adapted to the measured spectrum 61 into 170 bins of the same size over an interval which contains the profile with a width of 4 GHz. Oₙ(θ,i) is the number of expected counts of the respective i for the simulated spectrum in the nth bin.

Finally, the values χ², r₁′, r₃′ are tabulated for ρₜᵣₐₚ∈[35,100] ppm, (Δ_{⊙⊙}∈[0.5; 1.7] GHz) and θ₁∈[0; 0.6] rad. 500 iterations of the optimization over various spatial configurations of the remote traps are carried out for each value of ρₜᵣₐₚ, r₂ and θ₁. Only the 50 lowest values of χ² (the others are considered as outliers) are used and a weighted averaging is carried out for determining (χ²).

The 68% confidence interval for ρₜᵣₐₚ, (Δ_{⊙⊙}) and θ₁ is determined by min {<χ²>}+3.5. The results are illustrated in FIG. 6 and FIG. 7. The statistical error illustrated in FIG. 6 and FIG. 7 results from all the simulated spectra within the 68% confidence interval.

### Effects of Noise

The relative sensitivity to electric fields illustrated in FIG. 3 depends on how well the peak frequency of a spectral peak can be determined. The determination of the peak position is influenced by uncertainties caused by noise other than the stochastic shifts of the C-junction. Sources of such noise can be dark counts of the detector or undesired background fluorescence. The signal-to-noise ratio (SNR) required to enable the relative sensitivities shown in FIG. 3 is estimated. It is initially assumed that a dominates the response of the sensor to the interaction with an electric field such that the relative strong shift according to Eq. S1, which arises from two different resolvable electric fields E1 and E2, becomes the following equation:

$$\vert δω \vert = \frac{α}{2} \vert {E}_{1}^{2} - {E}_{2}^{2} \vert \qquad ( S11 )$$

$$= αδϵ {E}_{1}^{2} , \qquad ( S12 )$$

Here, the definition of the relative sensitivity of the electric field δϵ=|E₁−E₂|/E₁ is used and it is assumed that E₁+E₂≈2E₁ applies. The normalized uncertainty is defined as A=|δω|/γₕₒₘ, where the homogeneous line width of the SnV γₕₒₘ=35 MHz has been selected as a reference. A is the smallest strong shift difference that must be resolved in order to achieve a relative electric field sensitivity of SE.

In FIG. 14, the normalized uncertainty is illustrated for three values of SE, which are representative values from FIG. 3. The uncertainty normalized to the homogeneous line width for three different values of the relative electric field sensitivity is δϵ=1, 4, 7·10⁻⁷. For the range of the relevant field strengths, it is determined that 2.5·10⁻⁵<Λ≤10⁻⁴ applies. In order to understand the normalized uncertainty, the normalized uncertainty of the central peak position δω₀/γₕₒₘ of a spectral fitting with a centred Voigt profile V(ω−ω₀,γₕₒₘ,σ) with ω₀=0 a Lorentzschen component γₕₒₘ and a Gaussian component o is simulated in the presence of noise. If δω₀/γₕₒₘ resulting from the fitting does not exceed the threshold value required by Λ, it is assumed that the corresponding relative sensitivity of the electric field can be achieved. In FIG. 15, the result of the simulations is shown. The Gaussian component of the Voigt profile is normalized according to σₙₒᵣₘ=σ/γₕₒₘ. Here, SNR=10 log₁₀(A²/δₙₒᵢₛₑ²) is calculated, where the amplitude of the Voigt profile A=1 and δₙₒᵢₛₑ² is the amplitude of the white noise S(ω)=V(ω,γₕₒₘ,σ)+δₙₒᵢₛₑ.

FIG. 15 shows the required SNR as a function of σₙₒᵣₘ. The uncertainty extracted from the fitting as a function of the SNR and the component of the Voigt profile are both normalized to the homogeneous line width. Although the requirements are demanding, they do not represent a fundamental limitation of the proposed sensor. For the multimodal spectrum in FIG. 6, the normalized uncertainties are between 10⁻²≤Λ<7·10⁻¹. The unfavorable Λ in the experiment is mainly due to experimental shortcomings and does not represent a fundamental limitation of the sensor principle.

Even if Λ in the implementation does not achieve the simulated requirement to produce the simulated boundary of the relative sensitivity of the proposed electrometer, they are sufficient for the alleged Angstrom resolution of the sensor. A similar estimation of the normalized sensitivity can be carried out as a function of the relative resolution δϵᵣ=(r₁−r₂)/r₁, wherein similar assumptions are made as above (r₁+r₂≈2r₁) such that

$$Λ = 2 {δϵ}_{r} {a}^{2} \frac{α}{γ} ( \frac{1}{{r}_{b i a s}^{2} {r}_{1}^{2}} + \frac{1}{{r}_{1}^{4}} ) , \qquad ( S13 )$$

wherein a=¼πϵ₀ϵᵣ. It is determined that 18<Λ<166 for δϵᵣ=1, rbias=10 Å and r₁∈(10.30) Å, which far exceeds the given relative fitting uncertainties.

### Most Probable Spatial Trap Configuration

The integrated multimodal spectrum in FIG. 6 can arise from different spatial charge configurations, which can lead to identical results. However, the possible spatial charge configurations can be limited.

The integrated spectrum in FIG. 6 shows four peaks. The two simplest configurations which produce such a spectrum are: A) three traps 12, where one trap 12 is permanently charged and the other two are in the states [◯◯,◯⊙,⊙◯,⊙⊙] or B), four near traps 12, where one trap 12 is permanently charged and the other three are in the charge states. [◯◯◯,◯◯⊙,◯⊙◯,⊙◯◯]. In both cases, a bias field/permanently charged trap 12 is required to explain the inhomogeneous broadening of the right peak. There are many other trap configurations which could cause the same features, but these are less likely as they require more and more traps 12, with only a subset of all possible charge state combinations contributing to the observed spectrum. Of the two scenarios, the scenario A) requires the fewest additional assumptions.

The strongest argument for A) is the rate p(◯◯→⊙⊙)=3(1)%. If it is assumed that the traps independently ionize with a probability P, then the corresponding rates for B) are p(◯◯◯→⊙◯◯)≈P. However, this is one of the most unlikely processes. The scenario A) would require two ionization events which are of the order of magnitude P², which is much closer to the observation. The same argument can be applied for p(◯⊙→⊙⊙)=33(6)%. For B), the corresponding event would be p(◯⊙◯→⊙◯◯)≈P², which should be unlikely. However, the event of single ionization p(◯⊙→⊙⊙) is more likely and is therefore more consistent with the two-trap scenario.

The bias field to which the sensor is exposed is estimated by positioning a constantly ionized charge trap such that the inhomogeneous broadening of the simulations matches the observed line widths. From the simulations, a bias field results which causes a spectral shift of 1.27(0.4) GHz. This result is compared with the integrated spectrum 61 for lines between 0 and 200 from the spectrum in FIG. 6 and indications of a small blue shifted peak with a spectral shift of 1.24(2) GHz compared to the peak are found (cf. FIG. 16). FIG. 16 illustrates the experimental estimation of the bias field at the sensor by means of a background-subtracted integrated spectrum of the line scans between 0 and 200 as shown in FIG. 6. The fitting centred at 1.24 GHz indicates the existence of an additional charge trap 12 which is ionized most of the time. Thus, it is experimentally shown that there is actually a third 12 charge trap which is ionized most of the time. The analysis of the inhomogeneous line width with Monte Carlo simulations and experimental data independently confirm the estimated magnitude of the bias field. This correspondence also shows that the simulations can replicate the charge environment and are able to detect traps which do not dynamically change their charge on the time scales of the removed traps.

### Annealing

The formation of V₂ is understood as a consequence of implantation damage and the annealing process: the implantation damage arises during the collision cascade in the diamond lattice which decelerates the implanted ion. Collisions with an energy above the displacement threshold (≈37.5-47.6 eV, much smaller than the typical implantation energies) displace carbon atoms and generate Frenkel pairs: a pair of V₁ and a dislocated carbon atom located at an interstitial lattice site. After implantation, an annealing process is carried out to generate the color center by vacancy diffusion and to heal the lattice damage. At temperatures above 600 K, the interstitial carbon becomes mobile and at 800 K, the V₁ have a high degree of mobility. Consequently, the interstitial carbon can either recombine with the V₁ during annealing or diffuse away from the damage site and finally exit the sample via the interfaces. The V₁, which is not recombined with the interstitial carbon, can form an immobile V₂, vacancy cluster or together with the implanted ion a color center.

The model starts from a mobile species (V₁) and considers the formation of V₂ without multiple-vacancy complexes. Since multiple species are not taken into account, the assignment of different hopping frequencies is dispensed with. The initial number N and the 3D distribution of the V₁ after implantation are estimated by means of a SRIM simulation. Assuming that a certain percentage of V₁ that is not consumed by interstitial carbon, which is designated as the yield in % of the unrecombined Frenkel pairs (V₁ yield in FIGS. 11 and 12), a range of concentrations of V₂ is found, which are shown in FIG. 12 for the three atomic G4V species Si, Ge and Sn and different implantation energies. The distribution of V₂ in the sample is estimated by means of a kinetic Monte Carlo simulation. In each time step of the kinetic simulation, the V₁ can make a random step along one of the neighboring lattice sites. When two V₁ are next to each other, they form a static V₂ that no longer diffuses. The initial distribution of V₁ is estimated with SRIM. For each implantation energy, 50000 implantation events for a certain atomic species and implantation energy are used to determine the probability distribution p(z) of V₁ as a function of the depth z measured relative to the diamond surface (001). Then the p(z) are used to realize the spatial distribution of V₁ after a single implantation event. The V₁ are distributed on the diamond lattice according to p(z) along a narrow damage channel with a rectangular cross section of 2a×2a. The loss of V₁ that does not contribute to the formation of V₂ by recombination with interstitial carbon atoms is at a fixed percentage due to the reduction in the original amount of V₁, as determined in the SRIM simulation.

### Bulk Charges

Based on the model, an overview is given of the charge trap densities and the resulting inhomogeneous broadening with certain threshold values, the 90% interference visibility and >87% entanglement fidelity. First, a Monte Carlo simulation is used to determine the distributions of the line widths for a particular trap density p. A carbon density of ρ_{C}=8/a³ in bulk and an isotropic distribution of the traps 12 in the environment of the SnV at a given density p are assumed. For each ρ, 500 spatial trap configurations are considered which generate single peaks-ending spectra for ρ∈(1,100) ppm. Eq. (S9) and Eq. (S8) are used to calculate the spectra.

### Surface Charges

The surface density for both the semi-infinite half-space and the cylindrical geometry given in ppm is calculated with respect to a carbon density of ρ_{c}=2/a² [(001)-plane]. For the semi-infinite half-space, the traps 12 are randomly arranged on a square with an 100 nm edge length. The cylindrical surface has a height of 100 nm. The simulation of the inhomogeneous line width was carried out in both cases with the Monte Carlo method using 5000 different charge configurations for a single spatial configuration of traps 12. The electrostatic fields of a point charge on a surface are also used taking into account the corresponding boundary conditions. The electric field of a charge located on the surface of the semi-infinite half-space is:

$$\vec{E} ( q , {\vec{r}}_{q} ) = \frac{q}{2 {πϵ}_{0} ( {ϵ}_{r} + 1 )} \frac{{\vec{r}}_{q}}{{r}_{q}^{3}} . \qquad ( S14 )$$

For the cylindrical surface, a diamond cylinder with radius R extending to z=±∞ is assumed. No band bending is taken into account, which may be advantageous for the elimination of surface noise by shielding. In addition, shielding by free charge carriers is neglected because the strong reduction in sensitivity to charge noise is not seen, which would be expected even with moderate shielding lengths of a few tens of nanometers.

### Control Tests

Checking the Emission from a Single Transition

The sensor can be checked as to whether the multimodal spectral fingerprint originates from one and the same transition. Four characterization measurements are provided at a magnetic field of zero to exclude Zeeman splitting, which show that the signal originates from a single source and a single transition.

### Distribution of the Jump Width

In the 19 characterized emitters, jump distances ranging from a few hundred MHz to a few GHz were determined. In the examined samples, either one or two different jump processes or their combinations were found, which completely correspond to the number of the estimated lattice defects. The distribution of these distances is illustrated on the left in FIG. 17. FIG. 17 on the left shows the spectral jump ranges of characterized emitters. Emitters without hopping were stable during the line width scans, which took place in different periods of time between minutes and one hour. The error bars show the 95% confidence intervals of the central frequency distances extracted from the data.

The existence of unknown levels with quasi-forbidden transition rules therefore seems unlikely, since the jump distances for each emitter appear to be random.

### PL Spectrum

In FIG. 17 on the middle, a photoluminescence spectrum of E1 with ^{˜}850 GHz partitioning between C and D transitions is illustrated. The photoluminescence emission spectrum measured under 520 nm excitation light at 4 K according to FIG. 17 on the middle shows a typical SnV spectrum with detectable spectrometer-limited peaks assigned to the C (between the levels |1 [symbol] -|3 [symbol] , FIG. 6) and D (|2 [symbol] -|3> [symbol] transitions. Since they are at a distance of ˜850 GHz apart, it can be reliably claimed that a plurality of peaks from the PLE scan do not correspond to these transitions.

### Measurement of the Autocorrelation

The autocorrelation measurements presented in the control experiments for the model of the single-photon ionization charge dynamics originate from the emitter examined. The probability that a plurality of emitters contribute to the spectrum is made unlikely by an autocorrelation measurement with g⁽²⁾(0)=0.12(9)<0.5 close to the theoretical expected value of g⁽²⁾(0)=0.

### Rabi Frequencies of Different Resonances

Rabi oscillations between the levels |1 [symbol] and |3 [symbol] (C-junction) of an SnV are demonstrated at the emitter E2 at two different resonance frequencies before and after a spectral jump event. FIG. 17 on the right shows Rabi frequencies of the emitter E2 at different powers of both resonances. The values are extracted from a damped oscillation function at different resonant excitation powers (between the levels |1 [symbol] and |3 [symbol] . The data points were recorded before and after a spectral jump and thus at different frequencies. The uncertainties and error bars represent 95% confidence intervals which were extracted from the data. In the detailed view, Rabi oscillations are illustrated which were observed at 45.5 nW power at the higher-frequency resonance. The oscillations are achieved by resonance excitation after a green stabilizing pulse. The data after the rise time of the resonance laser are fitted to a damped oscillation function. After repeating the measurement at different powers, a slope of 20.9(9) Hz/\sqrt{nW} resulted for the low-frequency resonance, a slope of 21.2(1.8) Hz/\sqrt{nW} resulted for the higher-frequency resonance and a slope of 21.0(5) Hz/\sqrt{nW} resulted for the combined data set on a linear frequency-\sqrt{Power} line. The fact that the slopes for three data sets remained within the fitting error range strongly indicates that the dipole moment between the spectral jumps has not changed and that the same transition between the two measurements is addressed.

### Demonstration of Ionization Processes Via Single-Photon Processes Using Autocorrelation Measurements

One of the events that can occur during the laser irradiation is the transition of the group IV vacancy (G4V) emitters into a dark state. This manifests itself in shoulder-like focusing features around the anti-focusing decay in autocorrelation measurements. Using the assumption of a single-photon process from the model used, a linear power dependency is found for both the creation/capture of holes and for the transport of electrons. These experiments show that the image of the charge transfer is consistent with the measurements of the photon statistics. The analysis is based on the derivation of the autocorrelation function and the rate equations.

A system with three levels is assumed, wherein level 1 is the ground state, level 2 is the excited state and level 3 is a non-radiative shelving state, which is designated as G4V⁻². Such a system g⁽²⁾ with a non-zero background follows the following equation:

$${g}^{( 2 )} = 1 + {p}^{2} [ 1 - ( 1 + a ) exp ( - \frac{τ}{{τ}_{a}} ) + a exp ( - \frac{τ}{{τ}_{b}} ) ] , \qquad ( S15 )$$

wherein p determines the contribution of the background, τₐ is the anti-bunching time relating to the sink at 0 delay, τ_{b} is the bunching time determining the shoulders around the anti-bunching drop, and the parameter a is related to the transition rates. To check the model, g⁽²⁾ measurements of an SnV center at various powers (P) are fitted to this equation and the parameters are extracted. To predict the transition rates (k_{InitialFinal}), the following power relationships are then assumed:
In k₁₂ (incoherent excitation), a linear dependency on the power ‘δP’ is assumed, since it is a single-photon process in which an electron transitions from the ground state into quasi-continuous phononic bands of the excited state.
k₂₁ (spontaneous emission) is modeled at a constant rate ‘Γ’.
In k₂₃ (shelving), a linear power dependency ‘αP’ is assumed, since this process is known to be a single-photon process which transports electrons out of the valence band into an excited G4V.
k₃₁ (deshelving) is also modeled as linearly proportional to the power ‘βP’: Here, it is assumed that the hole provision is a single-photon process which is triggered by the transport of an electron out of the valence band into a Vₙ. So far, this rate has been modeled with a saturation curve, which can be attributed to the limited amount of contributing Vₙ. However, for this case, the Monte Carlo simulations predict an excessively high Vₙ density such that saturation can occur. Therefore, a linear model can detect the data well. A saturation curve can imitate a linear relationship at low powers and both models can function consistently in different ranges.

The bundling time τ_{b} is associated with the transition rates by the following equation:

$${τ}_{b} = \frac{1}{{k}_{31} + {k}_{23} \frac{{k}_{12}}{{k}_{12} + {k}_{21}}} \qquad ( S16 )$$

If k₁₂ is assumed to be much greater than k₂₁—as expected at higher powers—, then K₁₂/(k₁₂+k₂₁) tends towards 1. Consequently, the following applies:

$${τ}_{b} = \frac{1}{{k}_{31} + {k}_{23}} = \frac{1}{( α + β ) P} \qquad ( S17 )$$

This shows that τ_{b} is effectively determined by the total rate of k₃₁ and k₂₃ at higher powers. If a 1/x model is fitted to the extracted data τ_{b} in FIG. 18, it is shown that the model detects the data well and α+β is extracted as 7.5(1) kHz/μW. The total charge cycle rate of 1 MHz at ˜150 μW also appears reasonable, as it will be assumed that the charge transfer process is slower than the spontaneous emission or excitation.

To estimate the rate coefficients separately, the a parameter can be determined, which can be calculated by the following equation:

$$a = \frac{{k}_{23}}{{k}_{31}} \frac{{k}_{12}}{{k}_{12} + {k}_{21}} = \frac{α}{β} \frac{δ P}{δ P + Γ} . \qquad ( S18 )$$

At high powers, a parameter asymptotically reaches the value α/β. In FIG. 17, the extracted a values follow from the measurements of a saturation curve at which the fitting asymptotically approaches 0.40(3). From this relationship in Eq. S17, the shelving and deshelving rates at each power can be derived as a=2.2(2) kHz/μW and B=5.4(2) kHz/μW. Since the assumption of the linear power dependency corresponds to the observed data, it is assumed that single-photon processes are the main cause of the charge dynamics in the sample.

In FIG. 18, plots of the extracted parameters from the autocorrelation measurements for the emitter E1 are shown. The error bars represent 95% confidence intervals which were derived from the fits. These measurements on the left side show that shelving and deshelving processes can be modeled as single-photon events. The bunching time at different powers is given. The gray points are excluded from the calculation since they do not behave according to the approximated model at low powers and have large errors. The solid line represents the adaptation to a 1/(cP) function. In the box on the left in FIG. 18, selected example measurements can be seen. On the right side, the a parameter is plotted at various powers. The solid line represents the adaptation to a saturation curve.

### Interaction Between Charge Trap and Illumination Field

The properties of the laser can influence the spectral diffusion. Since the illumination triggers the ionization events in the sample, it is shown that the interactions and observed phenomena are compatible with the existence of charge traps.

### Position Dependence of the Stabilizing Laser and Measurement of the Subdiffraction Drift

A particular property of the ZPL of a SnV is that the spectral line drifted in correlation with the climate cycle of the laboratory. Simulations are carried out to reproduce the periodic changes and the inhomogeneous broadening of the determined PLE measurement. These simulations involve the introduction of periodic misalignment of the laser by varying the remote charge densities involved.

It is assumed that the blue stabilizing laser has a Gaussian intensity distribution in the z direction that oscillates over time:

$$I ( z , t ) = {I}_{0} {e}^{- {[ z - {z}_{0} ( t ) ]}^{2} / 2 σ} , \qquad ( S19 )$$

wherein I₀ is the peak intensity of the laser at the focal point, o is the focal length, and

$${z}_{0} ( t ) = a sin ( ω t ) . \qquad ( S20 )$$

The amplitude a describing the extent of misalignment due to temperature variations in the plant is not known. The frequency ω=2π/T corresponds to a T=10 min cycle. To carry out the Monte Carlo simulation, the previously described steps are followed, wherein the field generated by an ionized trap is given as follows:

$$\vec{E} ( q , \vec{r} ) = \frac{{q}_{i}}{4 {πϵ}_{0} {ϵ}_{r}} \frac{\vec{r}}{{r}^{3}} . \qquad ( S21 )$$

Traps 12 with a density of ρ=22.7 ppm are randomly distributed in a cubic volume with an edge length of 100 nm. The trap density reproduces well the inhomogeneously broadened line width of ˜103 MHz and that in FIG. 17 for a power-broadened homogeneous line width of ≈88 MHz. It is assumed that the probability that a trap participates in the ionization is given by P(t)=P(z,t)+P₀, wherein P(z,t)∝I(z,t) and P₀=0.1 is a constant background ionization probability. For the Monte Carlo simulation of the inhomogeneous line width, 2500 different charge configurations are used at each time step t. A very good correspondence with the results is found for a laser with a focal spot width of FWHM=240 nm (σ=FWHM/2\sqrt{2 log(2)}) and a vibration amplitude of a=200 nm. The results can be seen in FIG. 19.

For further confirmation of the model, a long-term PLE scan is carried out (FIG. 19) and the xyz control of the confocal microscopy setup for optimizing the fluorescence signal is used. By monitoring the changes in the spectral line, a ˜200 MHz drift is measured over a period of time of 3 hours, which corresponds to a shift of ˜50 nm according to the position optimizer. By realigning the setup, the original position of the resonance is restored, which further underpins the hypothesis.

Spectral drift relationships ˜0.2 MHz/nm and ˜4 MHz/nm for FIG. 19 are extracted. This means that, depending on the surrounding charge density, it would be reasonable to estimate a MHz/nm correspondence of the laser position drift to the emission mean frequency. Such a spectral test could prove useful to estimate the position drift below the diffraction limit. It has been proven that chirped pulses from an EOM can scan a range of 200 MHz in less than one second. Therefore, the use of a spectral approach would also enable a higher bandwidth that goes beyond the readout rates of the systems based on fluorescence intensity.

In total, an SnV or generally an emitter with inversion symmetry can be used to temporally resolve the remote charge trap density involved at any point in time. By correlating the central frequency, spatial drifts can be tracked in experimental systems.

In FIG. 19, plots of the influence of the laser misalignment on the PLE spectra are shown. In the left-hand plot, the simulation of the temporal change of the central position and the line width of the C-junction is illustrated which is caused by a periodic change of the alignment of the charge state stabilization laser which can result from temperature changes in the experiment. A power-broadened homogeneous line width of FWHMₕₒₘ=88 MHZ (left-hand line) is assumed and an inhomogeneous line width of FWHMₕₒₘ=103.3 MHZ (extracted from the fitting with a Voigt profile, right-hand line) is determined for given parameters of the charge state polarization laser. In the right-hand plot, an exemplary PLE measurement is shown which detects a drift of the resonance frequency. After optimizing the xyz position of the sample and of the laser spot, the central frequency returns to the original position.

### Method for Stabilizing the Emitter

The spectral properties of the emitters using different methods for charge stabilization with blue laser light are also examined in order to examine its interaction with the Vₙ. FIG. 20 shows PLE scans and spectra using two different stabilization methods with a charge stabilization laser at 450 nm and 300 nW average power. In the first scheme, continuous (CW) laser light is used during each PL scan (continuous stabilization). The second is a pulsed scheme: Before each PLE scan, the sample is irradiated with a blue laser pulse of duration 4 ms (pulsed stabilization). The PLE scans were performed at the emitter E1 with a resonance power of 0.7 nW, which is below the saturation power (>20 nW) and also low enough to avoid ionization during the scan.

FIG. 20 shows the two resonance peaks (˜1.4 GHz apart) which are also present in each individual line scan. The individual PLE scans of the pulsed scheme in FIG. 20 show that both resonances correspond to two different spectral positions of the C-junction, which is due to the Stark shift according to Eq. S1, which is caused by two different charge configurations of the ionized Vₙ in the vicinity of the SnV. With the resonance laser, a quasi-continuous fluorescence signal with the full inhomogeneous line width can be observed. By the continuous stabilization, the charge state of the environment is cyclically changed with a spectral jump rate Γ_{SH}>>Γ_{scan} which is much higher than the PLE scan rate, leading to two detectable peaks in individual PLE scans.

In FIG. 20, plots of the photoluminescence excitations of the C-junction under different charge stabilization schemes at the emitter E1 are shown. During the scans, a jump between two different resonances is observed. The resonance laser has a power of 0.7 nW and the blue laser has a power of 300 nW. The spectra were calculated with Voigt profiles. The uncertainties represent 95% confidence intervals which were extracted from the spectra. In the left-hand plot, the blue laser continuously illuminates the sample at 450 nm while the resonance laser measures. The continuous operation of the blue laser leads to a hopping which is faster than an individual line scan, leading to both peaks being observed in each individual scan. In the right-hand plot, a blue laser pulse of 4 ms is sent at the beginning of each scan. Without the aid of the blue laser, although the change between the two resonances is slower, it is still present on account of the laser which is in resonance with the C-junction.

Another significant signal for the increased ionization of Vₙ is the more pronounced inhomogeneous broadening of the resonance lines with continuous stabilization. 450 nm CW light leads to more traps in the environment being involved in the generation of the fluctuating electric field at the position of the emitter during each individual scan. Just as predicted in the Monte Carlo simulation, an increased activity of charge traps leads to an increased inhomogeneous broadening.

### Wavelength Dependence of the Stabilizing Laser

An indication that the charge dynamics and the occupation of traps in the vicinity play a role in the spectral jump phenomena results from the comparison of the charge stabilization with blue (450 nm) and green lasers (520 nm). In FIG. 21, the PLE spectra of the emitter E2, which were recorded under the same resonance and stabilizing laser powers, show an individual peak with the green laser, while a smaller second peak (albeit weak) can be observed when the blue laser is used. It has been shown that blue laser irradiation is more efficient for the charge trap ionization. It can be derived from this that a previously inaccessible charge trap is activated with the blue laser, which leads to the new discrete spectral jump. The spectroscopy of the charge trap transition rates could help to determine the ionization energies for individual charge trap types. For example, it is possible, albeit only qualitatively, to observe a faster switching fluorescence signal within the PLE recording resolution with the blue laser at each individual line, which results from fast spectral jumps.

In FIG. 21, plots of the photoluminescence excitations (PLE) of the C-junction under different colored stabilization schemes of the emitter E2 are shown. The C-laser had a power of 1 nW. The spectra were created using bimodal Voigt profiles. The uncertainties represent 95% confidence intervals which were extracted from the spectra. In the left-hand plot, the green laser is continuously turned on at 500 nW at 520 nm while the resonance laser scans. Continuous fluorescence of smaller peaks was sometimes observed. The secondary peak was not observable in this configuration. The spectra were recorded with a Voigt profile. In the right-hand plot, the blue laser is continuously turned on at 500 nW at 450 nm while the resonance laser scans. The blue laser generates a spectral jump which leads to a secondary peak. The spectrum was recorded with a bimodal Voigt profile.

### Power Dependence of the Stabilizing Laser

An extended resonance excitation of SnVs leads to a transition into a dark state. This was associated with a change of the charge state by the transport of an electron out of the valence band. A hole capture process induced by blue or green lasers can return the SnV back into its bright state. The use of higher powers or longer illumination times increases the probability of stabilizing the charge state and re-emission.

This is made possible by the ionization or charging of the defects around the quantum emitter, which act as charge/hole donors. As a result, the illumination changes the charge distribution around the color center and leads to a spectral diffusion. Therefore, charge stabilization and inhomogeneous broadening become competing effects, which have to be optimized for a qualitatively high-quality emission.

In FIG. 22, this conflict of aims is demonstrated on the basis of a measurement at the emitter E14. At a power of 7000 (375) nW, 30%, 9/30 (23%, 7/30) of the time result in bright lines and a histogrammed line width of 8 71 (204) MHz. Since charge traps 12 play such a decisive role in the stabilization of the bright state, a competition between the spectral diffusion and the efficiency of the stabilization of the charge state η_{bright} is expected. The ideal Vₙ density (or generally the density of the hole donors) can then be determined by a compromise between the minimization of the spectral diffusion and the maximization of η_{bright}.

In FIG. 22, plots of the comparison of the different stabilization pulse powers in the illumination of the emitter E14 are shown. Both measurements were carried out under 0.5 nW resonance laser excitation. Two different blue laser powers of 375 nW and 7000 nW were used. Higher powers resulted in a broadened inhomogeneous line width and more pronounced spectral drifts. The spectra were recorded with a Voigt profile. The uncertainties represent 95% confidence intervals which were extracted from the spectra. In the two left-hand plots, the measured fluorescence is shown at each cycle while the laser frequency was sampled. The two right-hand plots show histogrammed counts for the line width determination with a Voigt profile.

In addition, the contribution of the blue laser to the spectral diffusion as a function of its power was determined. In FIG. 23, measurements of the emitter E20, i.e. of the sample E014, are shown which had the same production parameters as E002 (five times higher dose than the sample E001), but with an additional sulfur co-implantation step. It can be clearly seen that higher blue laser light powers lead to a more pronounced broadening which has a certain degree of saturation, which, in turn, corresponds to the Monte Carlo simulations.

In FIG. 23, a plot of the comparison of the different stabilization powers at the emitter E20 is shown. The measurements were carried out on another sample which had a five times higher

Sn implantation dose and was co-implanted with sulfur. In all measurements, the same resonance excitation power of 5 nW is used, while the power of the blue permanent stabilization laser is varied. With increasing power of the blue laser, the line width becomes broader and reaches an asymptotic boundary. The insert shows an enlargement of the smaller powers in order to better illustrate the saturation trend. The error bars are the 95% confidence intervals which are strongly influenced by the background fluorescence caused by the high blue laser powers.

The features disclosed in the preceding specification, the claims and the drawing can be of importance both individually and in any combination for the realization of the various embodiments.

1. Method for locating charge traps in a crystal lattice, comprising the following steps:
arranging, at a crystal lattice, a local probe having an inversion-symmetric lattice defect, wherein energy levels of the lattice defect are non-linearly Stark-shiftable by means of charge traps in the crystal lattice;
determining, using a readout unit, Stark-shifted photoluminescence emission spectra, wherein each of the photoluminescence emission spectra is determined in a respective scanning operation by means of photoluminescence excitation in the crystal lattice;
determining an integrated spectrum by integrating the photoluminescence emission spectra;
determining jump probabilities from consecutive ones of the photoluminescence emission spectra and determining a charge trap configuration from the jump probabilities, wherein the charge trap configuration comprises a set of charge trap states of charge traps neighboring the local probe;
determining simulated spectra by means of Monte Carlo simulation based on a determined charge trap configuration and a resulting Stark shift, wherein spatial arrangements of the charge traps neighboring the local probe are varied, and
determining an optimal spatial arrangement of the charge traps neighboring the local probe by comparing the integrated spectrum with the simulated spectra.

2. The method according to claim 1, wherein the lattice defect of the local probe has a D_{3d} symmetry.

3. The method according to claim 1, wherein the local probe has a tin vacancy, a silicon vacancy, a germanium vacancy or a group IV vacancy.

4. The method according to claim 1, wherein arranging the local probe at the crystal lattice comprises implanting the local probe within the crystal lattice.

5. The method according to claim 1, wherein arranging the local probe at the crystal lattice comprises arranging the local probe close to the crystal lattice, wherein the local probe is embedded in a scanning probe microscope tip, in a nanocrystal, or in a biological sample.

6. The method according to claim 1, further comprising:
determining a plurality of peak frequencies of peaks from the integrated spectrum and frequency ranges of the integrated spectrum assigned to the peaks;
determining scanning operation peak frequencies of scanning operation peaks for each of the photoluminescence emission spectra and assigning the scanning operation peak frequencies to a respective one of the frequency ranges of the integrated spectrum assigned to the peaks; and
determining the jump probabilities from respective assigned frequency ranges for the consecutive ones of the photoluminescence emission spectra.

7. The method according to claim 1, wherein determining the charge trap configuration comprises:
determining a number of peaks of the integrated spectrum and a number of jump probabilities which are greater than a predetermined threshold value;
determining a number of charge traps of the charge trap configuration from the number of peaks and the number of jump probabilities.

8. The method according to claim 1, wherein determining the simulated spectra comprises:
determining approximate values for first location values of the spatial arrangements from relative Stark shifts from the integrated spectrum, and
fine tuning the first location values by means of Monte Carlo simulation, wherein the first location values and second location values of the spatial arrangements are varied,
wherein the optimal spatial arrangement comprises fine-tuned first location values and optimal second location values.

9. The method according to claim 1, wherein comparing the integrated spectrum with the simulated spectra comprises minimizing a χ² distribution from the integrated spectrum and the simulated spectra.

10. A device for locating charge traps in a crystal lattice, comprising:
a local probe having an inversion-symmetric lattice defect, which is arranged at a crystal lattice, wherein energy levels of the lattice defect are non-linearly Stark-shiftable by means of charge traps in the crystal lattice;
a read-out unit for photoluminescence spectroscopy; and
a data processing device, which is configured to carry out following steps:
determining, using the readout unit, Stark-shifted photoluminescence emission spectra, wherein each of the photoluminescence emission spectra is determined in a respective scanning operation by means of photoluminescence excitation in the crystal lattice;
determining an integrated spectrum by integrating the photoluminescence emission spectra;
determining jump probabilities from consecutive ones of the photoluminescence emission spectra and determining a charge trap configuration from the jump probabilities, wherein the charge trap configuration comprises a set of charge trap states of charge traps neighboring the local probe;
determining simulated spectra by means of Monte Carlo simulation based on a determined charge trap configuration and a resulting Stark shift, wherein spatial arrangements of the charge traps neighboring the local probe are varied, and
determining an optimal spatial arrangement of the charge traps neighboring the local probe by comparing the integrated spectrum with the simulated spectra.
